(19) United States
(12) Patent Application Publication
(10) Pub. No.: US 2025/0211408 A1
(43) Pub. Date: Jun. 26, 2025

(54) METHOD AND SYSTEM FOR COMMUNICATION IN A WIRELESS COMMUNICATION NETWORK ENABLED WITH SBFD OPERATION

(71) Applicants: Centre of Excellence in Wireless Technology, Chennai (IN); The Dean Industrial Consultancy & Sponsored Research, Chennai (IN)

(72) Inventors: Deepak Padmanabhan Mayakumari, Tamil Nadu (IN); Deepak Agarwal, Tamil Nadu (IN); Priyanka Dey, Tamil Nadu (IN); Jeniston Deviraj Klutto Milleth, Tamil Nadu (IN); Bhaskar Ramamurthi, Tamil Nadu (IN)

(21) Appl. No.: 18/990,442

(22) Filed: Dec. 20, 2024

(30) Foreign Application Priority Data
Dec. 21, 2023 (IN) 202341087834

(51) Int. Cl. H04L 5/14; H04B 7/06; H04W 24/10; H04W 72/0446

(52) U.S. Cl. CPC H04L 5/14; H04B 7/0626; H04W 24/10; H04W 72/0446

(57) ABSTRACT

The proposed invention relates to a method of performing communication in wireless communication network enabled with SBFD operation, and comprises configuring, by at least a first node, at least one first configuration for SBFD comprising one or more SBFD time resources. The method further comprises configuring at least one second configuration relating to at least one of transmission and reception of at least one of a signal and a channel, comprising an indication to perform the transmission and/or reception in either one or both SBFD time resources and non-SBFD time resources. The method also comprises performing the transmission and/or reception in SFBD time resource and/or non-SBFD time resource based on the at least one first configuration and the at least one second configuration. The performing of the transmission and/or reception is also performed by a second node, based on the first configuration and second configuration received from the first node.

### CROSS-REFERENCE TO RELATED APPLICATIONS

This application claims priority to India patent application Ser. No. 20/234,1087834, filed Dec. 21, 2023, which application is incorporated herein by reference in its entirety.

### FIELD OF INVENTION

The present disclosure generally relates to wireless communication, and specifically relates to performing of wireless communication in a network enabled with SBFD (Subband Full Duplex) operation.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Existing wireless communication systems or networks generally operate on technologies such as 5G-NR. The 5G-NR technology is designed based on TDD (Time Division Duplexing) technique, where a carrier can be configured for either DL (Downlink) or UL (Uplink) operations at a time. Such a technique uses time slots to separate the transmission and reception of signals on a single frequency channel, and hence, does not permit simultaneous performance of UL and DL operations. Such a disadvantage of existing technologies like 5G-NR is overcome based on the implementation of SBFD (Subband Full Duplexing) operation-based communication, which involves a node which can simultaneously perform DL and UL operations in different subbands within the same carrier frequency.

A subband is a set of frequency resources within the carrier. The subbands of the carrier frequency are used for UL and DL operations may be either on of fully overlapping, partially overlapping, or non-overlapping. In SBFD, subbands can be configured within the carrier and different set of operation can be configured within the subband. For instance, a UL subband can be configured within a DL carrier. Further, the SBFD operation can be enabled for a set of time resources, hereinafter referred to as SBFD active time resources, in which the subband is active. The SBFD active time resource can be contiguous or non-contiguous. The time resource granularity can be at symbol level, at slot level or resource type within a slot.

Despite the advantages of simultaneous UL and DL operations in a single carrier frequency, enabling of SBFD operations in a network may create several conflicts in the network system. Furthermore, enabling of SBFD operations may also create unnecessary transmission and/or monitoring at the nodes of the network. For instance, a UE (User Equipment) may be configured to receive signals in certain RBs (Resource Blocks) in a symbol of a carrier frequency. Thereby, the UE of a wireless communication network may keep monitoring the scheduled resources to receive a DL signal. However, a corresponding BS (Base Station) in SBFD operation mode does not perform DL operations in the RBs. Hence, the UE performs unnecessary monitoring in such an instance.

In addition to the unnecessary monitoring caused, enabling of SBFD operation in such an instance may create additional interference in the wireless communication network and impact various measurements carried out therein. The UE measures various channel and interference parameters in certain time and frequency resources and report it to the BS. The measurement is assumed to be valid for certain time duration, and one or more parameters for communication in the time duration may be determined by the BS based on the measurement report. However, the additional interference created by enabling of SBFD operation causes variation in channel and interference measurements.

Therefore, separate measurement of channel and interference parameters is needed for both SBFD active time resources and SBFD inactive time resources, where SBFD inactive time resources refers to a set of time resources corresponding to which SBFD operations are not enabled. Therefore, there arise a need for a method of transmission and reception of channels or signals in a communication network enabled with SBFD by overcoming drawbacks such as conflicts and interference arising due to SBFD operation.

### OBJECT OF THE INVENTION

An objective of the present invention is to enable wireless communication in a network enabled with SBFD so as to simultaneously perform UL and DL operations in the same carrier frequency.

Yet another objective of the present invention is to overcome conflicts and interference arising from SBFD operation in nodes of the network.

Yet another objective of the present invention is to perform transmission and reception of signals or channels in either one or both of SBFD time resource and non-SBFD time resource.

### SUMMARY OF THE INVENTION

In accordance with an embodiment of the present disclosure, a method for communication in a wireless communication network enabled with SBFD (Subband Full Duplex) operation with respect to a first node is provided. The method comprises configuring, by at least one first node, at least one first configuration for SBFD, where the at least one first configuration for SBFD comprises one or more SBFD time resources. The method further comprises configuring, by at least one first node, at least one second configuration relating to at least one of transmission and reception of at least one of a signal and a channel, where the at least one second configuration comprises an indication to perform at least one of transmission and reception in at least one of at least one first SBFD time resources and at least one first non-SBFD time resources. The method also comprises performing, by the at least one first node, one of the transmission and the reception in at least one of at least one scheduled SBFD time resource and at least one scheduled non-SBFD time resource based on the at least one first configuration and the at least one second configuration.

In one aspect, a time resource contains at least a symbol, wherein the time resource includes SBFD time resource and non-SBFD time resource.

In another aspect, the at least one scheduled SBFD time resource is at least one of the one or more SBFD time resources and the at least one scheduled non-SBFD time resource is at least one of the one or more non-SBFD time resource, wherein the one or more non-SBFD time resources are defined in the second configuration. The at least one second configuration comprises scheduling information for performing at least one of the transmission and the reception of at least one of the at least one signal and the at least one channel. The at least one of the at least one scheduled SBFD time resource and the at least one scheduled non-SBFD time resource is derived from scheduling information.

In another aspect, the at least one second configuration comprises at least one of at least one first CSI report configuration and at least one second CSI report configuration. When a single report configuration is provided in the second configuration for reporting of SBFD time resources and non-SBFD time resources, the first CSI report configuration corresponds to the single report configuration. When separate report configurations are provided in the second configuration for reporting of SBFD time resources and non-SBFD time resources, the first CSI report configuration and the second CSI report configurations corresponds to a first report configuration and a second report configuration of the separate report configurations respectively

In another aspect, the at least one second configuration further comprises at least one of a type field to indicate one of SBFD and non-SBFD, at least one report quantity for SBFD time resource, an indication to measure at least one CSI parameter for SBFD time resource, an indication to at least one resource set associated with SBFD time resource, and at least one sub-configuration. The at least second configuration further comprises a valid symbol type for CSI derivation, and the valid symbol type is one of SBFD time resource, non-SBFD time resource, and both SBFD and non-SBFD time resource.

In another aspect, the at least one sub-configuration comprises at least one of a sub-configuration type field to indicate one of SBFD and non-SBFD, at least one report quantity for SBFD time resource, an indication to measure at least one CSI parameter for SBFD time resource, and an indication to at least one resource set associated with SBFD time resource.

In another aspect, the second configuration further comprises transmitting a trigger signal to activate the CSI reporting. The trigger signal is used for activating at least one of at least one sub-configuration, at least one first CSI report configuration, and at least one second CSI report configuration. The trigger signal comprises at least one indicator to at least one of at least one sub-configuration, at least one first CSI report configuration, and at least one second CSI report configuration.

In another aspect, the at least one second configuration further comprises at least one of a CSI reference resource, a time restriction for measurement, a first CSI reference resource for non-SBFD time resource, a second CSI reference resource for SBFD time resource, a time restriction for non-SBFD time resource, a time restriction for SBFD time resource, and type of the time restriction for measurement as at least one of SBFD and non-SBFD.

In another aspect, the second configuration comprises one of at least one periodic CSI-RS resource and at least one semi-persistent CSI-RS resource.

In another aspect, the at least one second configuration comprises at least one of: at least one first resource set configuration and at least one second resource set configuration. The first resource set and second resource set are one of channel state information reference signal (CSI-RS) for downlink, and sounding reference signal (SRS) for uplink.

In another aspect, performing the reception is receiving a CSI report. The CSI report comprises at least one of at least one first CSI quantity for SBFD time resource and index of at least one first CSI-RS, and at least one second CSI quantity for non-SBFD time resource and index of at least one second CSI-RS. The least one first CSI quantity is measured in the at least one first CSI-RS, and the at least one second CSI quantity is measured in the at least one second CSI-RS

In another aspect, the reception is performed in at least one of RRC, DCI, and MAC-CE.

In another aspect, the first node is at least one of a BS (Base station), integrated access and backhaul (IAB) node and a distributed unit (DU).

In accordance with another embodiment of the present disclosure, a method for communication in a wireless communication network enabled with SBFD (Subband Full Duplex) operation with respect to a second node is provided. The method comprises receiving, by at least one second node, at least one first configuration for SBFD, wherein the at least one first configuration for SBFD comprises one or more SBFD time resources. The method further comprises receiving, by the at least the second node, at least one second configuration relating to at least one of transmission and reception of at least one of a signal and a channel, wherein the at least one second configuration comprises an indication to perform at least one of transmission and reception in at least one of SBFD time resources and non-SBFD time resources. The method also comprises performing, by the at least one second node, one of the transmission and the reception in at least one of at least one scheduled SBFD time resource and at least one scheduled non-SBFD time resource based on the at least one first configuration and the at least one second configuration.

In one aspect, performing the reception comprises at least one of measuring at least one first CSI quantity using at least one CSI reference signal (CSI-RS) in non-SBFD time resource, and measuring at least one second CSI quantity using at least one CSI-RS in SBFD time resource. The reception further comprises deriving at least one first CSI quantity based on the at least one second CSI quantity measured in the SBFD time resource, and deriving at least one second CSI quantity based on the at least one first CSI quantity measured in the non-SBFD time resource.

In another aspect, the at least one first CSI quantity is derived when one of CSI-RS is not received in non-SBFD time resource before the CSI reference resource, and CSI-RS is not received in non-SBFD time resource before first CSI reference resource for non-SBFD time resource. Deriving at least one second CSI quantity is when one of CSI-RS is not received in SBFD time resource before the CSI reference resource, and CSI-RS is not received in SBFD time resource before second CSI reference resource for non-SBFD time resource.

In another aspect, the transmission is performed based on determining whether a report is to be transmitted. The report comprises at least one of at least one first CSI quantity for non-SBFD time resource and index of at least one first CSI-RS, and at least one second CSI quantity for SBFD time resource and index of at least one second CSI-RS. The at least one first CSI-RS is used for measuring the at least one first CSI quantity, and the at least one second CSI-RS is used for measuring the at least one second CSI quantity.

In one aspect, the report is transmitted only when at least one CSI-RS is received in at least one of SBFD and non-SBFD time resource before CSI reference resource. The report is transmitted only when at least one of at least one CSI-RS is received in non-SBFD time resource before first CSI reference resource for non-SBFD time resource, and at least one CSI-RS is received in SBFD time resource before second CSI reference resource for SBFD time resource.

In another aspect, wherein transmission of the report is dropped when at least one of CSI-RS is not received before CSI reference resource, CSI-RS is not received in SBFD time resource before the CSI reference resource, CSI-RS is not received in non-SBFD time resource before the CSI reference resource, CSI-RS is not received in non-SBFD time resource before the first CSI reference resource for non-SBFD time resource, and CSI-RS is not received in SBFD time resource before the second CSI reference resource for SBFD time resource.

In another aspect, when the time restriction for non-SBFD time resource is configured, the method further comprises measuring at least one first CSI quantity using the most recent CSI reference signal (CSI-RS) received in non-SBFD time resource before one of the CSI reference resource and the first CSI reference resource. When the time restriction for SBFD time resource is configured, the method further comprises measuring at least one second CSI quantity using the most recent CSI reference signal (CSI-RS) received in SBFD time resource before one of the CSI reference resource and the second CSI reference resource. When the time restriction is configured, the method further comprises measuring at least one first CSI quantity using the most recent CSI reference signal (CSI-RS) received in non-SBFD time resource before one of the CSI reference resource and the first CSI reference resource, and measuring at least one second CSI quantity using the most recent CSI reference signal (CSI-RS) received in SBFD time resource before one of the CSI reference resource and the second CSI reference resource.

In another aspect, the second node is is at least one of a UE (User Equipment) and a mobile terminal (MT).

In accordance with another embodiment of the present disclosure, a BS for communication in a wireless communication network enabled with SBFD (Subband Full Duplex) operation is provided. The BS comprises a processor configured to configure at least one first configuration for SBFD, where the at least one first configuration for SBFD comprises one or more SBFD time resources. The processor is further configured to configure at least one second configuration relating to at least one of transmission and reception of at least one of a signal and a channel, where the at least one second configuration comprises an indication to perform at least one of transmission and reception in at least one of at least one first SBFD time resources and at least one first non-SBFD time resources. The processor is also configured to perform one of the transmission and the reception in at least one of at least one scheduled SBFD time resource and at least one scheduled non-SBFD time resource based on the at least one first configuration and the at least one second configuration.

In accordance with another embodiment of the present disclosure, a UE for communication in a wireless communication network enabled with SBFD (Subband Full Duplex) is provided. The UE comprises a processor configured to receive at least one first configuration for SBFD, wherein the at least one first configuration for SBFD comprises one or more SBFD time resources. The processor is further configured to receive at least one second configuration relating to at least one of transmission and reception of at least one of a signal and a channel, wherein the at least one second configuration comprises an indication to perform at least one of transmission and reception in at least one of SBFD time resources and non-SBFD time resources. The processor also performs, by the at least one second node, one of the transmission and the reception in at least one of at least one scheduled SBFD time resource and at least one scheduled non-SBFD time resource based on the at least one first configuration and the at least one second configuration.

### BRIEF DESCRIPTION OF THE DRAWINGS

Having thus described the embodiments of the disclosure in general terms, reference now will be made to the accompanying drawings, which are not necessarily drawn to scale, and wherein:

FIGS. 1(a), 1(b), and 1(c) illustrate non-overlapping bands, partially overlapping bands, and fully overlapping bands in SBFD operation, in accordance with an embodiment of the present invention.

FIG. 2 illustrates a SBFD active time resources within a resource grid of a carrier frequency, in accordance with an embodiment of the present invention.

FIG. 3 illustrates an exemplary overlap of a BWP of a UE with a subband for SBFD operation, in accordance with an embodiment of the present invention.

FIG. 4 illustrates a flowchart of steps of the proposed method executed by a BS, in accordance with an embodiment of the present invention.

FIG. 5 illustrates a flowchart of steps of the proposed method executed by a UE, in accordance with an embodiment of the present invention.

FIG. 6 illustrates a flowchart of the steps executed by a BS and a UE in a wireless network enabled with SBFD operation, in accordance with an embodiment of the present invention.

FIG. 7 illustrates an exemplary system for performing communication in a wireless network enabled with SBFD operation, in accordance with an embodiment of the present invention.

### DESCRIPTION OF THE INVENTION

The description set forth below in connection with the appended drawings is intended as a description of various embodiments of the present invention and is not intended to represent the only embodiments in which the present invention may be practiced. Each embodiment described in this invention is provided merely as an example or illustration of the present invention, and should not necessarily be construed as preferred or advantageous over other embodiments. The description includes specific details for the purpose of providing a thorough understanding of the present invention. However, it will be apparent to those skilled in the art that the present invention may be practiced without these specific details.

Some embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

Existing method of wireless communication are generally based on technologies such 5G-NR (Fifth generation New Radio) designed based on TDD (Time Division Duplexing) technique. In TDD, a carrier signal may be configured for either of DL or UL operation at a time. The transmission and reception of signals are performed by a node of the communication network in different time slots of a single frequency channel in TDD, which restricts the simultaneous performance of UL and DL operations. SBFD (Subband Full Duplexing) operation-based communication is used for overcoming the above-mentioned limitation in existing technologies, wherein a node simultaneously performs DL and UL operations in different subbands of the same carrier frequency or same frequency channel.

In SBFD technique, a subband relates to a set of frequency resources within a carrier frequency. The subbands used by a node for DL or UL operations may be fully overlapping, partially overlapping, or non-overlapping. While SBFD operation-based communication offers the benefit of simultaneous UL and DL operations to nodes of a wireless communication network, it also presents several drawbacks. The proposed method relates to steps for overcoming the drawbacks associated with SBFD operation, primarily relating to additional interference created in the wireless communication network and its impact on the various measurements required to be performed in UL and DL operations.

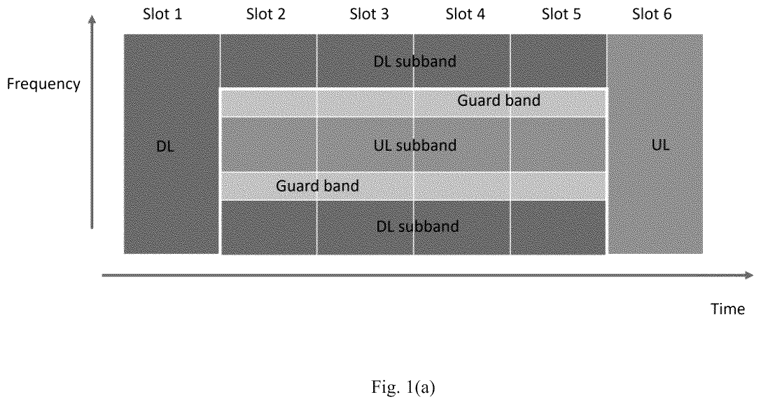

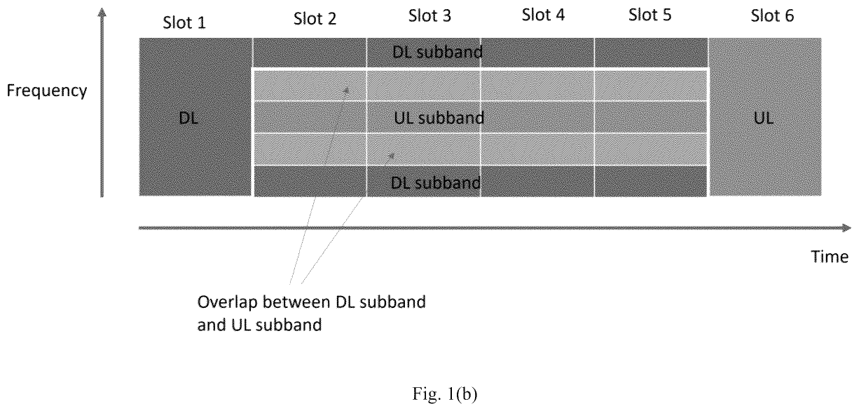

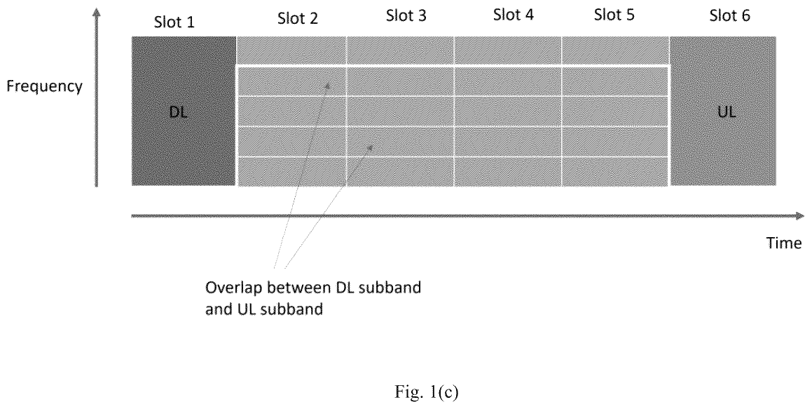

A first drawback of SBFD operation relates to self-interference (SI) created by simultaneous transmission and reception in a node, where the simultaneous transmission or reception is based on utilization of either one of fully overlapping bands, partially overlapping bands, or non-overlapping bands, as illustrated in FIGS. 1(a), 1(b), and 1(c). In case of SBFD operation in non-overlapping subbands, guard bands may be used between DL and UL subbands of the carrier frequency to minimize the impact of SI, as illustrated in FIG. 1(a). For SBFD operation in partial and fully overlapping subbands, additional interference cancellation mechanisms are needed to handle SI.

In SBFD operation, the subbands within a carrier frequency may be configured, and different set of operations may be configured within a subband. For instance, a UL subband may be configured within a DL carrier. Furthermore, SBFD operation may be enabled for a set of time resources, hereafter referred to as SBFD active time resources, in which the subband is active for SBFD operation. The SBFD active time resource can be contiguous or non-contiguous time resources, where the time resource granularity can be at symbol level, at slot level or resource type within a slot.

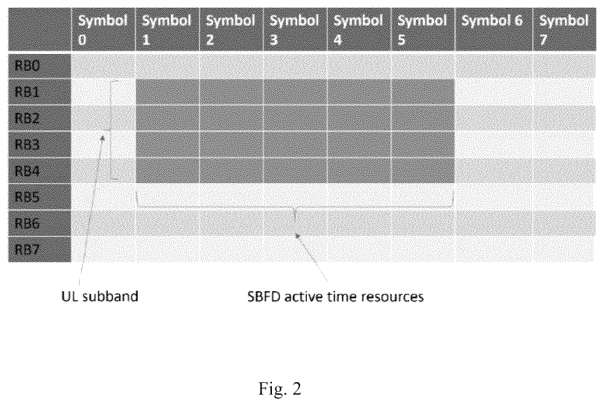

FIG. 2 illustrates a SBFD active time resources within a resource grid of a carrier frequency, in accordance with an embodiment of the present invention. The resource grid comprises 8 resource blocks (RBs) within a carrier, configured for DL operation using conventional methods. The resource blocks RB1 to RB4 are configured as UL subband and it is active from symbol 1 to symbol 5. Hence, in symbols 1 to 5, a BS can simultaneously perform a DL transmission to a UE using resource blocks RB0, RB5, RB6 and RB7, and can receive a UL transmission from another UE in resource blocks RB1 to RB4.

In cellular network-based wireless communication, a BS may operate using multiple carrier, wherein operation with respect to each carrier may be based on use of a large bandwidth. However, a UE does not have access to all such carriers, or to an entire bandwidth of each carrier. The set of frequency resources for which the UE does have access within a carrier is known as bandwidth part (BWP). A UE can be configured with multiple BWPs, and a subset of the multiple BWPs configured to the UE may be active at a time. Further, separate BWPs can be configured for DL and UL operations performed by the UE. In SBFD operation-based in such a cellular communication network, in certain instances, a BWP configured to a UE may overlap with a subband used for SBFD operation. In such instances, the size of the BWP may vary in SBFD active time resource depending on the nature of overlap with the SBFD subband.

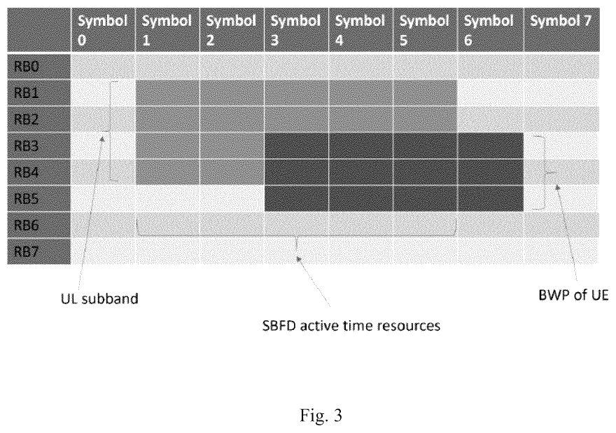

FIG. 3 illustrates an exemplary overlap of a BWP of a UE with a subband for SBFD operation, in accordance with an embodiment of the present invention. In the example illustrated in FIG. 3, the UE is configured with a DL BWP from resource blocks RB3 to RB5, and a UL subband for SBFD operation is defined from resource blocks RB1 to RB4. Hence, in such an instance, there arises a partial overlap between the DL BWP of UE and UL subband for SBFD operation with respect to resource blocks RB3 and RB4, which are common for both the DL operation and UL operation. In such a scenario, the BS performs UL operation using the UL subband in the SBFD active time resources, i.e., symbol 1 to symbol 5. Hence, the UE will not receive any DL signal in DL BWP overlapping with UL subband (i.e., in resource RB3 and RB4 corresponding to symbols 3-5. Therefore, in SBFD active time resources, the DL BWP of UE consist of resource block RB5 alone in symbols 1 to 5, whereas the DL BWP of the UE consist of RB3 to RB5 in other time resources such symbol 0, symbol, 6 and symbol 7.

A second drawback of the SBFD based-operation is that enabling of SBFD operation in a wireless communication network may create several conflicts in the communication system. Further, it may also cause unnecessary transmission and/or monitoring to be performed at the nodes of the communication network. For instance, with respect to the example illustrated in FIG. 3, the UE may be configured to receive signals in the resource blocks RB3-RB5 corresponding to symbol 3. Hence the UE keeps monitoring the scheduled resources to receive DL signal, as it expects to receive such signals in the resource blocks RB3-RB5 corresponding to symbol 3. However, the BS, in SBFD mode, is not performing DL operation in RB3 and RB4 in symbol 3. Hence, nodes may be caused to perform such unnecessary monitoring due to enabling of SBFD operation.

In addition to the first and second drawbacks of SBFD-based operation in wireless communication networks, enabling of SBFD operations also results in a third drawback relating to creation of additional interference in the network and impacts various measurements. For instance, with reference to the example illustrated in FIG. 3, the BS performs simultaneous DL transmission and UL reception in symbols 1 to 5, creating SI at the BS. Further, in the wireless communication network, a UE is receiving DL signals from the BS, and another UE is simultaneously transmitting UL signals to the BS in an SBFD symbol. Therefore, the UL transmission from the UE interfere with DL reception, creating UE-to-UE interference.

Another impact of SBFD is in channel state information (CSI), configuration for CSI and procedures associated with CSI. The UE measures various channel and interference parameters in certain time and frequency resources and report it to the BS by means of a report. The report is used for providing information relating to relevant parameters of the channel to the BS for determining parameters for performing transmission and reception of data in the channel. E.g., transmit power of data signal, the modulation and coding scheme to be used for transmission of data signal, etc. The report is generated by the UE based on report configurations configured by the BS. Various parameters relevant to the channel such as channel quality indicator, signal to noise ratio, rank, precoder information, etc which are measured by the UE based on reference resources configured to the UE by the BS. The measured parameters are reported back to the BS based on the report configuration. In case of SBFD, the channel conditions differ in SBFD and non-SBFD time resources. E.g., the additional interference created by SBFD operation, impacts the value of CQI or SINR measured in SBFD time resource and non-SBFD time resource. Therefore, separate measurement and reporting of channel parameters for SBFD time resource and non-SBFD time resource is necessary.

### Existing Method of CSI Reporting Based on Report Configurations

In existing methods of CSI reporting, the UE is configured with CSI-report configurations by the BS, where each CSI report configuration indicates to the UE the parameters to measure, method to compute the parameters, the resources to send the report, etc. Further, each CSI-report configuration is associated with one or more CSI-RS resource sets, where each resource set comprises one or more CSI-RS resources. The UE performs computation of different parameters of the channel, indicated by the CSI report configuration, using the received CSI-RS resources, and reports the parameter to the BS by means of a CSI report.

For example, in an existing method of report configuration implemented in 5G-NR, a UE may be configured with one or more CSI-RS resource sets using an information element (IE) CSI-ResourceSetConfig in RRC (Radio Resource Control) message. The IE may indicate an identity of the CSI-RS resource set, whether the CSI-RS resource set is for channel measurement or interference measurement, the identity of the CSI-RS resources within the resource set, time domain behaviour of resource set, etc. The time domain behaviour of the CSI-RS resource set indicates whether the CSI-RS resources within the CSI-RS resource set is periodic, semi-persistent or aperiodic. Further, details regarding the CSI-RS resources are configured to the UE using the IE CSI-ResourceConfig in RRC message. E.g., scheduling of CSI-RS resources, transmit power associated with a CSI-RS resource, beam related information, etc.

In the case of periodic CSI-RS resources, the CSI-RS resources within the CSI-RS resource set are transmitted to UE at regular intervals. Further, the reception of periodic CSI-RS resources starts immediately after the configuration of the report configuration to the UE. In case of semi-persistent CSI-RS resources, the CSI-RS resources within the CSI-RS resource set are transmitted periodically after a trigger event has occurred. The UE first receives a trigger from BS semi-statically using MAC-CE, followed by CSI-RS resources at regular intervals. In case of aperiodic CSI-RS resources, the CSI-RS resources within the CSI-RS resource set are transmitted only once based on scheduling, after a dynamic trigger. Therefore, the UE receives dynamic trigger followed by the aperiodic CSI-RS transmission.

The details of the CSI-RS resource set for channel measurement are provided to the UE using an NZP-CSI-RS-ResourceSet IE in RRC message, which indicates the identities of the CSI-RS resources forming the CSI-RS resource set for the channel measurement. The NZP-CSI-RS-ResourceSet IE further indicates an offset between the triggering and the transmission of the CSI-RS resources, information relating to antenna elements (or antenna ports) of the channel used for transmission of CSI-RS resources of the CSI-RS resource the set etc. The details of the CSI-RS resource sets for interference measurement are provided to the UE by a CSI-IM-ResourceSet IE, which indicates the identities of the CSI-RS resources assigned or configured for interference measurement forming the CSI-RS resource set. The NZP-CSI-RS-Resource IE in RRC is used to configure CSI-RS resources for channel measurement to the UE. The IE indicates an identity of the configured CSI-RS resource, the mapping of CSI-RS resource within a resource block, power control parameters, TCI state information, periodicity and offset, etc.

The UE performs CSI measurements across its BWP. Each CSI-RS resource, configured to the UE, occupies certain resource elements (REs) and OFDM symbols in a resource block. The UE assumes the same mapping pattern across all RBs within its BWP depending on the density of the CSI-RS. If the density is one, the mapping pattern is repeated across all RBs in the BWP. If the density is half, then alternate RBs contain CSI-RS and follow the same mapping pattern. Hence, each CSI-RS resource spans across whole BWP of UE and the UE performs CSI measurements using the CSI-RS resource received across its BWP.

In such methods of CSI reporting performed in existing wireless communication technologies, a UE may be configured by the BS using one or more report configurations to transmit the CSI report generated based on the use of the CSI-RS resources, wherein the reporting is performed using IEs. For example, a CSI-ReportConfig IE may be used in RRC message. In such existing methods, the UE may be configured to transmit CSI report periodically, in a semi-persistent manner based on trigger, or aperiodically. Such a configuration is done by the element reportConfigType in CSI-ReportConfig of the report configuration configured to the UE by the BS. The element which reportConfigType in CSI-ReportConfig can be set to ‘aperiodic’, ‘semiPersistentOnPUCCH’, ‘semiPersistentOnPUSCH’, or ‘periodic’ by the BS.

The entity reportConfigType further indicates whether the CSI report is to be transmitted in UL control channel or UL data channel, and the scheduling of the control/data channel. The periodic CSI report is always transmitted in UL control channel. The semi-persistent report may be transmitted in UL control channel based on MAC-CE trigger or in UL data channel based on dynamic trigger depending on the configuration performed by the BS. The aperiodic CSI report is always transmitted in UL data channel.

The CSI-ReportConfig configures the resources for transmitting the CSI report. For ‘periodic’ and ‘semiPersistentOnPUCCH’/‘semiPersistentOnPUSCH’ CSI reporting, the configured periodicity and slot offset may be applied in the numerology of the UL BWP in which the CSI report is configured to be transmitted on. For periodic and semi-persistent CSI reporting, the periodicity and slot offset may be configured using a reportSlotConfig element. The UE can determine the frame number and slot number within the frame to transmit the CSI report based on periodicity and slot offset indication in the reportSlotConfig elemeny and a mapping rule defined in NR specification. Separate mapping rule is defined for semi-persistent reporting on PUCCH and PUSCH. For semipersistent CSI reporting on PUSCH and aperiodic CSI reporting, the possible set of slot offsets are configured using a reportSlotOffsetList IE in CSI-ReportConfig element and the triggering DCI down selects one value from the set.

The CSI-ReportConfig element indicates the CSI-RS resources in which the UE has to measure the CSI parameters. The indication is using CSI-ResourceConfigID, which selects one or more groups of CSI-RS resource sets configured to the UE using CSI-ResourceConfig. Further, the indication is separate for CSI-RS resources for channel measurement and CSI-RS resources for interference measurement. For example, the group of CSI-RS resource sets selected by one CSI-ResourceConfigID contain only CSI-RS resources for channel measurement. Similarly, the group corresponding to CSI-ResourceConfigID, indicated by CSI-ReportConfig, contains only CSI-RS resources for interference measurement.

The CSI-ReportConfig is also used for configuring the CSI parameters to be reported, and for configuring the assisting information that may be used by the UE for calculating the values of the CSI parameters to be reported. The element reportQuantity in CSI-ReportConfig may be used to indicate to UE to report either ‘none’, ‘cri-RI-PMI-CQI’, ‘cri-RI-i1’, ‘cri-RI-i1-CQI’, ‘cri-RI-CQI’, ‘cri-RSRP’, ‘cri-SINR’, ‘ssb-Index-RSRP’, ‘ssb-Index-SINR’, ‘cri-RI-LI-PMI-CQI’, ‘cri-RSRP-Index’, ‘ssb-Index-RSRP-Index’, ‘cri-SINR-Index’ or ‘ssb-Index-SINR-Index’. The assisting information may comprises index of the CQI table, from the set of tables defined in NR specification, to be used for calculation of CQI, the codebook configuration for calculation of PMI, ports to be used for measurement of CQI, etc.

CSI-ReportConfig may also be used for configuring whether the UE has to measure the parameter for whole BWP or subband within the BWP. The CSI-ReportConfig may be used for configuring the UE for wideband reporting subject to satisfaction of one or more conditions. Alternatively, the UE may be configured to report in subband frequency-granularity, and in such an instance, the CSI-ReportConfig may further indicate the CSI parameters to be reported in subband basis, size of subband, number of subbands within the BWP etc. If an element cqi-FormatIndicator in CSI-ReportConfig is configured as wideband then the UE reports single wideband CQI for the entire CSI reporting band. If the element cqi-FormatIndicator in CSI-ReportConfig is configured as subband then, UE reports CQI per subband.

Similarly, the UE reports wideband or subband PMI depending on the element pmi-FormatIndicator. In the case of subband reporting, the element csi-ReportingBand in CSI-ReportConfig indicates whether the subbands are contiguous or non-contiguous in the bandwidth part which CSI shall be reported for. The element csi-ReportingBand indicates a bit string where each bit in the bit-string represents one subband. The right-most bit in the bit string represents the lowest subband in the BWP. The bandwidth of the subband is determined by the UE based number of PRBs in the BWP and element subbandSize in CSI-ReportConfig. A table is defined in NR specification, illustrated in Table. 1 below, relating the number of PRBs in BWP of UE and possible values for subband size. UE select one row from Table. 1 or possible values for subband size based on the size of BWP. Further, the element subbandSize in CSI-ReportConfig indicates whether to use value1 or value2 from the selected row.

TABLE 1

| Bandwidth part (PRBs) | Subband size (PRBs) |
|---|---|
| 24-72 | 4, 8 |
| 73-144 | 8, 16 |
| 145-275 | 16, 32 |

After receiving the CSI-RS resources, the UE requires time to process the CSI-RS resource, compute the CSI parameters and prepare the report. Hence there should be a time gap between the CSI resource measurement and sending CSI report. For transmitting a CSI report in a time instant, the UE will consider only the CSI-RS resources received before certain duration from the CSI reporting time and that time duration is characterized by CSI reference resource. Therefore, CSI reference resource is defined as the minimum time duration, from the CSI reporting time, before which a CSI-RS resource need to be received at the UE so that the UE can measure CSI parameters based on the CSI-RS resource and include it in the CSI report. For example, if the CSI reference resource is configured as 4 slots and the UE is configured to report CSI in slot n, then the UE measures the configured CSI parameters using the CSI-RS resources received no later than slot n−4. Further, the UE reports CSI report only if it receives at least one configured CSI-RS resource before the CSI Reference resource. After the CSI report configuration or reconfiguration, serving cell activation, BWP change, or activation of SP-CSI, the UE reports a CSI report only after receiving at least one CSI-RS transmission occasion for channel measurement and CSI-RS and/or CSI-IM occasion for interference measurement no later than CSI reference resource and drops the report otherwise.

In the case of CSI reporting, the UE measures a CSI resource in multiple time instances, evaluates the CSI parameters for multiple time instances and averages them to obtain the value of the parameter for reporting. The time restriction for measurement is configured to the UE to avoid averaging of the parameters based on multiple CSI resources. For example, if the time restriction is configured to the UE, then the UE determines CSI parameter based on the latest CSI-RS resource received before CSI reference resource. The CSI-ReportConfig can configure elements timeRestrictionForChannelMeasurements and timeRestrictionForInterferenceMeasurements to enable time domain restriction for channel measurements and interference measurement, respectively.

In NR specification, several behaviours are defined with respect to measurements performed by the UE with regard to time restrictions. The defined behaviours include deriving of the channel measurements by the UE for computing CSI value reported in uplink slot n based on only the CSI-RS resources for channel measurement, no later than the CSI reference resource, associated with the CSI resource setting if the higher layer parameter timeRestrictionForChannelMeasurements is set to “notConfigured”. Further, the defined behaviour also includes deriving of the channel measurements by the UE measurements for computing CSI reported in uplink slot n based on only the most recent, no later than the CSI reference resource, occasion of CSI-RS resources for channel measurement if the higher layer parameter timeRestrictionForChannelMeasurements in CSI-ReportConfig is set to “Configured”.

The defined behaviour in NR specification also includes deriving of the channel measurements by the UE measurements for computing CSI value reported in uplink slot n based on only the CSI-RS resource for interference measurement no later than the CSI reference resource associated with the CSI resource setting, if the higher layer parameter timeRestrictionForInterferenceMeasurements is set to “notConfigured”, the UE shall derive the interference measurements. Further still, the defined behaviour in the NR specification also includes deriving of the interference measurements by the UE for computing the CSI value reported in uplink slot n based on the most recent, no later than the CSI reference resource, occasion of CSI-RS resource for interference measurement associated with the CSI resource setting, if the higher layer parameter timeRestrictionForInterferenceMeasurements in CSI-ReportConfig is set to “Configured”.

### CSI Reporting in by UE in Wireless Communication Network Enabled with SBFD

As discusses previously with regard to methods of CSI reporting in existing wireless communication technologies, periodic CSI resources are configured to the UE and are transmitted at regular intervals or based on configured periodicity. The UE receives the periodic CSI resources over multiple occasions, measures the parameters based on the periodic CSI resources, average the measured parameters across the occasions and report the parameters in the respective CSI reporting instant. The parameters to report and the scheduling for reporting are configured to the UE in CSI report configuration. In semi-persistent CSI measurement and reporting, the CSI resources are configured to the UE along with periodicity. The BS transmits trigger, in MAC-CE or DCI (Downlink Control Information), to initiate the measurement and reporting of semi-persistent CSI resources. The trigger also indicates the CSI resources to measure and scheduling information for reporting., The semi-persistent CSI resources are transmitted at regular intervals based on configured periodicity. The UE receives the CSI resources over multiple occasions, measures the parameters based on the CSI resources, averages the measured parameters across the occasions and reports the parameters in the respective CSI reporting instant.

In the case of a wireless communication network enabled with SBFD operation, the CSI resources may overlap with the resources configured for SBFD operation, in which the BS will be performing UL operation. Therefore, the CSI resources won't be transmitted in at least the resources overlapping with SBFD resources. Consequently, the UE may receive only partial CSI resources. Further, network conditions such as interference may be different in an SBFD resource and non-SBFD resource, and can impact the CSI measurement. For example, a UE may be configured to report CSI parameter CQI in slot n+10 and the report configuration is associated with a periodic CSI resource transmission from slot n with periodicity of 2. Therefore, the UE expects CSI-RS transmission, across DL BWP, in slot n, slot n+2, slot n+4, slot n+6, slot n+8, etc. In existing methods, the UE would have received CSI resources in these set of slots, computed CQI corresponding to each slot, averaged the CQI computed and reported the average value in slot n+10.

However, the same example, when occurring in a communication network enabled with SBFD operation, may result in the DL BWP of the UE overlapping with the UL SB for SBFD operation. In such an example, if SBFD operation is enabled in slot n+2 and slot n+6, an option that may be considered with respect to measurement of CSI-RS and computation of CQI may involve the BS not transmitting the CSI-resources in slot n+2 and slot n+6 to the UE. In such an option adopted, the UE skips measurement of CSI-RS and computation of CQI in slot n+2 and slot n+6. Further, UE will assume the CQI parameters are the same in SBFD and non-SBFD symbol, which may have a tolerable error. In another case, the UE computes the parameters for SBFD symbol based on measurement in non-SBFD symbol.

Another option that may be implemented in such an example involves the BS only transmitting CSI-RS in resources that are not overlapping with UL subband in slot n+2 and slot n+6. Hence, in such an option, the UE receives only partial CSI-RS in slot n+2 and slot n+6, which may affect the quality of CQI. Further, in slot n+2 and slot n+6, another UE is performing UL with BS in UL subband, which can interfere with CSI-RS reception at the UE. Therefore, CSI-RS reception in slot n+2 and slot n+6 is subject to additional interference which can impact the SINR (Signal-to-Interference-plus-Noise Ratio) measurement and CQI computation significantly.

Therefore, the channel condition and value of the parameters for CSI reporting may vary in SBFD and non-SBFD scenarios. Assuming the parameters to be the same and averaging the parameters computed in SBFD and non-SBFD scenarios can result in error and inaccuracy. Therefore, the UE should perform separate measurement of CSI parameters in resources configured for SBFD and non-SBFD. Also, UE should report them separately to the BS.

Further, the measurement is assumed to be valid for certain time duration and parameters for communication such as modulation and coding scheme. Such parameters for communication are determined in the time duration by the BS based on the report generated by the UE. However, the additional interference created by SBFD causes variation in channel and interference measurements. For example, an increase in the interference in SBFD active time resource results in a reduction in signal to interference-noise ratio, which in turn vary the channel quality, reported by the UE using parameters such as CQI, and the MCS calculation.

Therefore, separate measurement of channel and interference parameters is needed for SBFD active time resources and time resources where SBFD operation in disabled, hereafter referred to as SBFD inactive time resources. Further, the UE perform measurements using reference signal which span across a set of time and frequency resources. In an SBFD active time resources, the number of time and frequency resources for measurement decreases, resulting in a reduction in the accuracy of measurement. For example, in NR, channel and interference measurements are performed using CSI-RS (Channel State Information Reference Signal), spanning across the whole BWP of UE. However, in an SBFD active time resource, the BWP of the UE overlapping with SBFD subband become inactive, and hence, the UE does not receive any CSI-RS resource in the inactive portion. For instance, with reference to the example illustrated in FIG. 3, a UE receive CSI-RS in all resource blocks RB3-RB5 corresponding to symbol 6, whereas UE receive CSI-RS only in resource block RB5 corresponding to downlink subband in symbols 3 to 5. Thus, it can be concluded that the accuracy of parameters measured in symbol 6 may vary from the accuracy of parameters measured symbols 3-5.

A fourth drawback of SBFD based operation in wireless communication relates to the difficulty in adaptation of bandwidth with respect to SBFD active time resources. Flexible adaption of the channel bandwidth is required in cellular technologies where a large bandwidth is required for supporting a variety of services and for satisfy the increasing demand of data rates. Flexible adaption of the channel bandwidth is required for saving energy at the BS. For instance, in certain scenarios, the BS can turn off transmission/reception in certain frequency range to reduce energy consumption. With respect to SBFD operation, similar adaptions may include turning off transmission and/or reception in subbands of SBFD operation. The adaptions of bandwidth may be performed based on many parameters such as network load, user equipment (UE) uplink-downlink (UL-DL) traffic etc.

However, the adaptation of bandwidth creates issues similar to SBFD mentioned above, i.e., issued relating to creation of additional interference and impacts on various measurements. For example, a UE can be semi-statically configured by a BS for periodic receptions within certain frequency resources. Adapting of the bandwidth dynamically by the BS may cause deactivation of certain portions of the frequency resources configured to the UE, that leads to unnecessary monitoring by the UE. Therefore, information about the bandwidth adaptation, such as information relating to subband and activation time, performed at one node of a communication network is to be signalled to other nodes of the network in order to reduce the impact of issues created by SBFD operation.

The method proposed in the present invention aims at overcoming the above-mentioned drawbacks associated with enabling of SBFD operation for wireless communication, and further involves steps for adapting bandwidth of channel measurement and reporting framework in a cellular network. Additionally, the proposed method also includes various signalling exchanges and configuration of behaviour of nodes for efficient measurement and reporting of various parameters of the channel in a network enabled with SBFD and/or involving bandwidth adaptation. The signalling exchanges and configurations involved in the method proposed in the present invention is also applicable for any scenario involving adaption of bandwidth.

The proposed method involves using at least a first configuration relating to configuration of SBFD resources, and at least a second configuration relating to transmission and/or reception of a signal and/or a channel, and performing of the transmission and/or reception based on the first configuration and the second configuration. The proposed method may be implemented by either one or both of a BS or a UE for transmission and/or reception of a signal and/or a channel, wherein such transmission and reception includes transmission and reception of data, transmission and reception of reports, or transmission and reception of configurations including the first configuration and the second configuration.

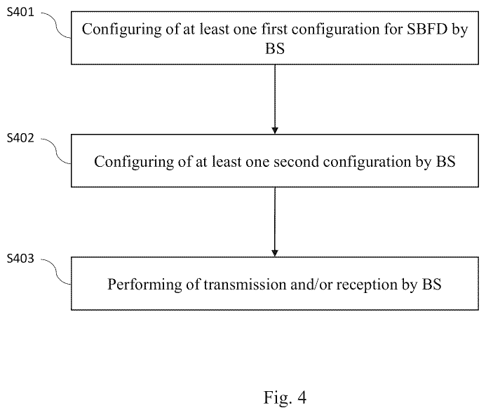

In a first embodiment of the present invention, the proposed method may be performed by a BS, an integrated access and backhaul (IAB) node or a distributed unit (DU) for performing transmission and/or reception of signals. FIG. 4 illustrates a flowchart of steps of the proposed method executed by a BS, in accordance with an embodiment of the present invention. Step S401 involves configuring at least one first configuration for SBFD by a BS. Herein, the configuring of the first configuration by the BS involves configuring of different resources essential to SBFD operation. The first configuration configured by the SBFD comprises one or more SBFD time resources, wherein SBFD time resources relates to time resources where SBFD operation is to be enabled. The time resources referred to herein contains at least a symbol, and a type of a symbol, hereafter referred to as symbol type, and a valid symbol type may be one of SBFD time resource and non-SBFD time resource.

Step S402 involves configuring of at least one second configuration by the BS. The second configuration relates to transmission and/or reception of a signal and/or a channel, wherein an indication comprised in the second configuration is used for determining whether the transmission and/or reception is to be performed in either SBFD time resources, non-SBFD time resources, or both SBDF and non-SBFD time resources.

Configuring of the second configuration by the BS in step S402 also includes configuring a scheduling information, included in the second configuration, for the performing of transmission and/or reception of at least one signal and/or at least one channel. Herein, the transmission and/or reception of the at least one signal and/or the at least one channel may be performed in at least one scheduled SBFD time resource and/or at least one scheduled non-SBFD time resource. The at least one scheduled SBFD time resources and the at least one scheduled non-SBFD time resources are determined based on the scheduling information received in the second configuration.

As discussed previously with respect to CSI reporting in by UE in wireless communication network enabled with SBFD, the channel condition and value of the parameters for CSI reporting may vary in SBFD and non-SBFD scenarios. Hence, as assuming the parameters to be the same and averaging the parameters computed in SBFD and non-SBFD scenarios may result in error and inaccuracy, the BS in the proposed method configures the report configuration such that separate reports are generated for SBFD time resources and non-SBFD time resources.

Hence, the configuring of the second configuration by the BS in step S402 involves configuration of a either a single report configuration for separate reports corresponding to SBFD time resources and non-SBFD time resources, or separate report configurations for the separate reports corresponding to SBFD time resources and non-SBFD time resources. In case of single report configuration for SBFD time resource and non-SBFD time resource, the BS configures at least one first CSI report configuration. In case separate report configurations are required for

SBFD time resource and non-SBFD time resource, at least one first CSI report configuration and at least one second CSI report configuration are configured by the BS.

If separate report configurations are to be configured by the BS for SBFD time resource and non-SBFD time resource, different options may be used by the BS to link the report configurations to either SBFD time resource or non-SBFD time resource. In a first option, the second configuration may be configured by the BS such that it comprises a type field to indicate one of SBFD and non-SBFD, i.e., to indicate the type of operation for which the report configurations of the second configuration are created for. For example, a new field CSIReport-Config-Type can be introduced in CSIReport-config (report configuration). If CSIReport-Config-Type=SBFD then the report configuration is for SBFD scenario and a UE (to which the report configuration is configured) is expected to measure parameters, configured in CSIReport-Config, in SBFD symbols. Similarly, if CSIReport-Config-Type=non-SBFD then the report configuration is for non-SBFD scenario. and the UE is expected to measure parameters, configured in CSIReport-Config, in non-SBFD symbols.

In a second option that may be adopted by the BS for configuring separate reports configurations, the BS may configure the second configuration such that it comprises at least one report quantity defined for SBFD time resource. If a first or second CSI report configuration of the second configuration comprises the new report quantity for SBFD scenario, then the report is for SBFD scenario. In such an instance, the measurement and reporting of CSI parameters based on the corresponding report configuration is performed only in SBFD symbols. For example, if ReportQuantity=subband-SINR, then the report configuration is for SBFD, and the UE measures interference introduced due to SBFD operation. In another example., in CSIReport-config if ReportQuantity=cri-RI-CQI and ReportQuantity-Rel18=subband-SINR, then the UE reports parameters cri, RI and CQI in SBFD symbols. In addition, UE computes SINR in SBFD symbols and report it to BS along with Cri-RI-CQI.

In a third option that may be adopted by BS with respect to report configuration, the second configuration may be configured by the BS such that it comprises a type of the quantity (or CSI parameter) that is to be measured and reported. Hence, the type of quantity can be indicated to the UE performing the measurement and reporting along with CSI report configuration. For example, if CSIReport-config contains IE CQIformatIndicator=SBFD then the report configuration is for SBFD. The UE should compute CQI in SBFD symbols and report to BS.

In a fourth option, the second configuration configured by the BS may comprise a type of the resource set associated with report configuration used by the UE for performing measuring and reporting of the CSI report, wherein the type of the resource set configured within the second configuration by the BS may be used to differentiate whether the report configuration is for SBFD scenario or non-SBFD scenario. For example, if all CSI-RS resource sets associated with CSI-report configuration correspond to SBFD scenario then the CSI-report configuration is for SBFD scenario and vice versa. New IE can be defined by the BS in CSI-RS resource set configuration to indicate whether the CSI-RS resource set belongs to SBFD or non-SBFD scenario, where the new IE indicates the type of the resource set. For instance, the BS can configure CSI-RSResourceSetTye=SBFD in CSI-RS resource set configuration to indicate the resources within the resource set belongs to SBFD.

In many instances, the BS may be required to configure a single report configuration corresponding to separate reports relating to SBFD and non-SBFD operation. Such instances may occur when the number of CSI reports that can be processed by the UE is limited by UE capability. The UE should have large number of CPUs and memory to handle several CSI reports simultaneously. In addition, the CSI reports are used for several purposes other than channel measurements, e.g., beam management, mobility management, etc. Hence, there is constraint in defining several CSI report configurations. Therefore, methods to enable separate CSI reporting for SBFD and non-SBFD scenarios using single CSI report configuration is essential, especially in case of lower UE capability.

Hence, in step S402, the configuring of a second configuration by the BS may involve adoption of one or more different options for enabling so separate CSI reporting for SBFD and non-SBFD scenarios using a single CSI report configuration, and the single CSI report configuration is hereafter referred to as the first CSI report configuration. In a first option, the first CSI report configuration configured by the BS may comprises a new report quantity defined for SBFD. The new report quantity is configured within the first CSI report configuration by the BS to the UE which is to perform the CSI measurement and reporting. For example, CSIReport-config comprises an existing element ReportQuantity=cri-RI-CQI, and the new IE, i.e., new report quantity, ReportQuantity-Rel18=cri-RI-CQI, then the corresponding UE reports parameters cri, RI and CQI in non-SBFD symbols as well as in SBFD symbols. The new IE can also indicate report quantities which are specific to SBFD scenario. For example, if ReportQuantity-Rel18=SINR-CQI, then UE computes CQI and SINR in SBFD symbols and report it to BS along with existing report quantities.

In a second option, the BS may configure a new format during configuring of the first report configuration, wherein the new format can be specified for report quantity in report configuration. This method is useful when SBFD has impact only on certain CSI parameters alone. For example, if CQI is only parameter impacted by SBFD, then the BS can configure in CSIReport-config, ReportQuantity=cri-RI-CQI and CQIformatIndicator=SBFD, then UE measures CRI and RI using existing mechanisms or in non-SBFD symbols and measures two CQI values: one based on measurements in non-SBFD symbols and one corresponding to SBFD symbols.

In a third option, the configuring of the first CSI report configuration by the BS involves configuring of a type of resource set. The type of the resource set, comprised within the first CSI report configuration, can be used to differentiate whether to report parameters for SBFD scenario, non-SBFD scenario or both. For example, if ReportQuantity=cri-RI-CQI in CSI-report configuration (i.e., first CSI report configuration) and all CSI-RS resource sets associated with CSI-report configuration correspond to SBFD scenario then the UE has to report CRI, RI and CQI for SBFD scenario. Similarly, if CSI-RS report configuration is associated with CSI-RS resource set1 corresponding to SBFD scenario and CSI-RS resource set2 corresponding to non-SBFD scenario, then UE has to report CRI, RI and CQI for both SBFD and non-SBFD scenarios. New IE can be defined in CSI-RS Resource set configuration to indicate whether the CSI-RS resource set belongs to SBFD or non-SBFD scenario. For example, the BS can configure CSI-RSResourceSetTye=SBFD in CSI-RS resource set configuration to indicate the resources within the resource set belongs to SBFD.

In a fourth option, a type of resource set may be configured by the BS within the first CSI report configuration configured by the BS. The type of resource set comprised in the first CSI report configuration can be used to differentiate whether to report parameters mentioned in the report for SBFD scenario, non-SBFD scenario or both. For example, if ReportQuantity=cri-RI-CQI in CSI-report configuration (i.e., first CSI report configuration) and all CSI-RS resource sets associated with CSI-report configuration correspond to SBFD scenario then the UE has to report CRI, RI and CQI for SBFD scenario. Similarly, if CSI-RS Report configuration is associated with CSI-RS resource set1 corresponding to SBFD scenario and CSI-RS resource set2 corresponding to non-SBFD scenario then UE has to report CRI, RI nd CQI for both SBFD and non-SBFD scenarios. New IE can be defined in CSI-RS Resource set configuration to indicate whether the CSI-RS resource set belongs to SBFD or non-SBFD scenario. For example, BS can configure CSI-RSResourceSetTye=SBFD in CSI-RS resource set configuration to indicate the resources within the resource set belongs to SBFD.

In a fifth option, multiple sub-configurations can be configured within the first CSI report configuration by the BS, where one set of sub-configurations corresponds to SBFD and second set of sub-configurations corresponds to non-SBFD. When option is adopted by the BS for configuration of the first CSI report configuration, different options may be further adopted by the BS with respect to configuring a type of each sub-configuration. For configuration of type of each sub-configuration, a first option that may be adopted by the BS involves configuring each sub-configuration with a subconfiguration ID and subconfigurationtype, which can be configured as SBFD or non-SBFD.

In a second option relating to configuring type of each sub-configuration, a new report quantity can be defined for SBFD and can be indicated in the sub-configuration. For example, if a sub-configuration is associated with ReportQuantity=cri-RI-CQI-SBFD, then that sub-configuration is for SBFD scenario. In a third option relating to configuring of each sub-configuration, a type of report quantity can be configured to the UE along with sub-configuration. For example, if a sub-configuration comprises COIformatIndicator=SBFD, then that sub-configuration is for SBFD scenario. In a fourth option, a type of resource set associated with sub-configuration may be configured by the BS, and can be used to differentiate whether the sub-configuration is for SBFD scenario or non-SBFD scenario.

In case of periodic CSI reporting, if a first report configuration is configured by the BS with sub-configurations corresponding to SBFD and non-SBFD scenario, then the UE computes CSI parameters for SBFD and non-SBFD scenario separately based on the first report configuration configured to the UE by the BS, and report it to the BS. Further, in case of semi-persistent or aperiodic CSI reporting, one of the sub-configurations can be activated by trigger signal. For example, an aperiodic CSI-report configuration comprises 2 sub-configurations. First sub-configuration with subconfiguration ID=SC1 and subconfigurationtype=SBFD and second subconfiguration with subconfiguration ID=SC2 and subconfigurationtype=non-SBFD. If the DCI, triggering aperiodic CSI report, indicates subconfiguration ID=SC1 to the UE, then the UE only computes CSI parameters for SBFD scenario and report it to the BS.

In case CSI report configuration with multiple sub-configurations, the resources for CSI computation by a UE to which the first configuration is configured to by the BS can be linked to a first CSI report configuration or to the sub-configuration. The linking of resources for CSI computations to the first CSI report configuration or the sub-configuration is configured by the BS. Different approaches may be adopted by the BS for linking of resources, and a first approach involves linking of the resources for CSI measurement to the first report configuration. Hence, in such an approach, the CSI resource set can be the same for the sub-configurations associated with the CSI-ReportConfig. If the BS configured a UE with plurality of resources, where some resources are received in SBFD symbol and some in non-SBFD symbol, then the UE groups the CSI resources into two groups: one in SBFD symbol and other in non-SBFD symbol, separately measures the parameters for each group and report them to the BS separately based on first CSI report configuration configured by the BS.

In the first approach, if a resource configured by the BS to the UE falls in SBFD and non-SBFD symbols, then the UE may be configured by the BS to group the resource occasions into two groups: the occasions in which the resource falls in SBFD symbol and occasions in which the resource falls in non-SBFD symbol. Based on the first CSI report configuration comprised in the second configuration transmitted to the UE by the BS, the UE measures the CSI parameters separately for each group and report them to the BS separately. For example, a UE is configured with periodic CSI-RS resource, starting from slot n with periodicity of 2 slots. Therefore, the CSI-RS resource will be transmitted in slot n, slot n+2, slot n+4, etc. If the slots n+2, slot n+5 and slot n+6 are configured for SBFD operation, then the CSI resource occasions in slot n+2 and slot n+6 falls in SBFD slot. In such a scenario, the UE, based on the second configuration comprising the first CSI reporting configuration, performs grouping of the CSI occasions into two groups: first group comprising CSI occasions in slot n, n+4, n+8, etc., and second group comprising CSI occasions in slot n+2 and n+6. The UE measures the configured CSI parameters separately for first group and second group, and report both set of CSI parameters to the BS, based on the first CSI reporting configuration of the second configuration configured by the BS.

A second approach that may be adopted by the BS for linking of resources for report configuration involves linking of the resources for CSI measurement to individual sub-configurations. For example, a set of resources, scheduled in SBFD symbols, are associated with a sub-configuration for reporting parameters of SBFD Symbols. Similarly, a second set of resources, scheduled in non-SBFD symbol, is associated with the sub-configuration for reporting parameters of non-SBFD symbol.

Hence, if configuring of the first CSI report configuration, which relates to a single CSI report configuration corresponding to separate reporting of CSI parameters for the SBFD time resources and the non-SBFD time resources, involves configuration of one or more sub-configurations, the BS configures the single CSI report configuration (also referred to herein as first CSI report configuration) such that the CSI resources are configured to the first CSI report configurations, or to each of the sub-configurations. Similarly, the CSI-RS resources for required for CSI measurement and reporting corresponding to SBFD and non-SBFD operations are also configured within the second configuration by the BS, in step S402.

The configuring of the second configuration by the BS with respect to the CSI-RS resources involves indicating, by the BS, to a UE performing the CSI measurement and reporting, whether to report CSI parameters for non-SBFD scenario, SBFD scenario, both, or the existing manner of CSI reporting using the report configuration. Additionally, the BS may configure separate resources for measuring parameters for SBFD scenario and non-SBFD scenarios. The BS can configure the periodicity and offset of the CSI resources such that the CSI resources are transmitted only in SBFD scenario or in SBFD symbols. For example, the PeriodicityAndOffset parameter in NZP-CSI-RS-Resource IE can be selected such that the CSI-RS resource maps to SBFD occasions. Further, the BS can ensure that these resources are associated with a report configuration that enable CSI measurement and reporting at UE for SBFD scenario.

Hence, the second configuration comprises at least one first resource set, wherein the first resource set may be used for measurement and reporting of either an SBFD operation or a non-SBFD operation, corresponding to scenarios where CSI reporting corresponding to either SBFD operation and non-SBFD operation is to be performed. The second configuration may also comprise at least one second resource set, corresponding to scenarios where CSI reporting corresponding to both SBFD operation and non-SBFD operation is to be performed. In such instances, the second resource set CSI reporting corresponding to SBFD operation if the first resource set is used for non-SBFD operation, or vice-versa. The configuring of the resource sets within the second configuration by the BS will also involve configuring of type field for indicating whether the resource sets relate to SBFD operation or non-SBFD operation, where the type field maps a resource set to SBFD operation or non-SBFD operation. Further, the configuring of resources within the second configuration is such that the second configuration comprises at least one periodic CSI-RS resource and at least one semi-persistent CSI-RS resource.

In case of separate CSI report configuration for SBFD and non-SBFD, the report configuration for SBFD scenario (i.e., either the first CSI report configuration or the second CSI report configuration) will be associated with set of CSI resources which maps to SBFD occasion. Similarly, the report configuration for non-SBFD scenario (i.e., either the first CSI report configuration if the second CSI report configuration is associated SBFD, or the second CSI report configuration if the first CSI report configuration is associated with SBFD) is associated with set of resources mapping to non-SBFD occasion. The mapping with report configuration can be used by the UE to differentiate CSI resource set for SBFD scenario and non-SBFD scenario. For example, the resource set linking to CSI report configuration corresponding to SBFD scenario is considered as CSI resources corresponding to SBFD scenario. In an embodiment, a first resource set and a second resource set, relating to CSI-RS resources configured for SBFD operation and non-SBFD operation, are CSI-RS for downlink transmissions and SRS (Sounding Reference Signal) for uplink transmission.

In the case of single CSI report configuration, the same report configuration will be associated with more than one set of CSI resources, where a first set contains resources mapping to SBFD scenario and a second set of resources contains mapping to non-SBFD scenario. New IEs may be defined in the resource set configuration to indicate whether the resources within the resource set corresponds to SBFD scenario or non-SBFD scenario. For example, the defining of the new IE may be as CSI-RSResourceSetType=SBFD or non-SBFD. For measuring parameters associated with SBFD scenario, the UE uses the CSI-RS resource set with CSI-RSResourceSetType=SBFD, and for measuring parameters corresponding to non-SBFD, the UE uses CSI-RS resource set with CSI-RSResourceSetType=non-SBFD. The UE treats the CSI-RS resource set without the CSI-RSResourceSetTpye configured as non-SBFD.

In certain embodiments of the present invention, the configuring of CSI-RS resources and resource set by the BS in step S402 within the second configuration is done without considering the mapping to SBFD and non-SBFD scenario. In such an embodiment, the explicit indication about whether resource belongs to SBFD scenario or non-SBFD scenario may not be provided to a UE performing the CSI measurement and reporting. The UE determines the resources within resource set corresponding to SBFD and non-SBFD scenario based on the information about SBFD parameters. In the embodiment, the BS indicates the subband for SBFD operation and the time instances where the subband is active to the UE. The CSI-RS resources mapping to time and frequency resources overlapping with SBFD resources is treated as CSI-RS resources corresponding to SBFD scenario and vice versa. In this case, the CSI report configuration can link to resource set comprising CSI-RS resources for SBFD and non-SBFD scenario. The UE determines the resources within resource set corresponding to SBFD based on the information about SBFD parameters, measure the parameters indicated by report configuration and report the parameter to the BS. Similar is the case with non-SBFD operation scenario.

The CSI-RS resources configured by the BS in the second configuration for CSI measurement and reporting may be indicated to a UE which is perform such CSI measurement and reporting as a trigger signal. The trigger signal is transmitted by the BS for activating CSI reporting by the UE, following which the UE may perform CSI reporting based on the second configuration received from the BS. The BS can indicate to UE whether to measure the CSI parameters in SBFD resource, non-SBFD resource or both in trigger for CSI reporting. For example, a new field can be indicated in DCI, triggering an aperiodic CSI reporting which can be configured as {SBFD alone, non-SBFD or both}. If the DCI triggering aperiodic reporting indicates Reportype=SBFD, then the UE determines CSI-RS resources corresponding to SBFD scenario, based on BS configuration or based on parameters configured for SBFD, measure the parameters and report to BS. Similar is the case if DCI triggering indicate report type as non-SBFD. Similar fields can be introduced in MAC_CE triggering semi-persistent CSI reporting as well.

The configuring of the trigger signal within the second configuration by the BS may be such that the trigger signal, in addition to activating the CSI reporting, also activated at least one of at least one sub-configuration, at least one CSI report configuration, and at least one second CSI report configuration. The trigger for activation of at least one sub-configuration is configured by the BS in scenarios where one or more sub-configurations corresponding to a single report configuration is configured in the second configuration by the BS. The trigger for activation of at least a first CSI report configuration is configured by the BS for activating a single report configuration for separate reporting of SBFD and non-SBFD operations.

The trigger for activation of at least a second CSI report configuration is configured by BS when separate report configurations are defined by the BS for reporting relating to SBFD and non-SBFD operation. In such an instance, if the first CSI report configuration is associated with SBFD operation, then the second CSI report configuration is associated with non-SBFD operation, or vice versa. In certain embodiment, the trigger signal configured by the BS may further comprise an indicator to at least one of at least one sub-configuration, at least one CSI report configuration, and at least one second CSI report configurations, for the purpose of activating such configurations.

The configuring of second configuration by the BS in step S402 further includes configuring of a valid symbol type for CSI derivation. The valid symbol type may be one of an SBFD time resource or a non-SBFD time resource, or may be both SBFD and non-SBFD time resource. The configuring of second configuration by BS also includes the configuring of a CSI reference resource, and a time restriction for measurement of CSI parameters/quantities. The CSI reference resource CSI reference resource is the minimum time duration, from the CSI reporting time, before which a CSI-RS resource need to be received at the UE so that the UE measure CSI parameters based on the CSI-RS resource and include it in the CSI report. The time restriction for measurement is configured to the UE to avoid averaging of the parameters based on multiple CSI resources.

The configuring of CSI reference resource also includes configuring of the steps to be executed or approach to be adopted by the UE corresponding to the different scenarios associated with CSI reference resource. A first scenario involves when the UE receives CSI-RS is received for both non-SBFD and SBFD scenario before the CSI report configuration. In such a scenarios, the second configuration involves configuring the UE to transmit a CSI report, containing CSI parameters corresponding to SBFD and non-SBFD scenario, to the BS based on the CSI report configuration. In a second scenario, the UE may not receive in either SBFD symbol or non-SBFD symbol at least one CSI-RS before CSI reference resource. In such a case the UE is configured to drop the entire CS report.

In a third scenario, the UE may receive in non-SBFD symbol at least one CSI-RS before CSI reference resource and not receive in SBFD symbol at least one CSI-RS. In such a case, one option that may be configured to the UE is to transmit CSI report containing CSI parameters corresponding to non-SBFD scenario to the BS based on the CSI report configuration, where the CSI report configuration is obtained from the second configuration received by the UE in step S502. Another option that is configured to the UE is to drop the entire CSI report. Yet another option that is configured to the UE is to transmit a complete CSI report based on CSI report configuration, obtained from the second configuration. In such an option, the UE is configured to derive the CSI parameters for SBFD scenario based on the CSI-RS resource in non-SBFD symbol.

In a fourth scenario, the UE may be configured to receive in SBFD symbol at least one CSI-RS before CSI reference resource and not receiving in non-SBFD symbol at least one CSI-RS in non-SBFD symbol. In such a case, one option configured to the UE may be to transmit CSI report CSI parameter corresponding to SBFD scenario to the BS based on the CSI report configuration obtained from the second configuration. Another option that may be configured to the UE may be to drop the entire CSI report. Yet another option configured to the UE may be to transmit the complete CSI report based on CSI report configuration obtained from the second configuration received by the UE. The UE derives the CSI parameters for non-SBFD scenario based the CSI-RS resource received in SBFD symbol.

In a fifth scenario, separate CSI reference resources may be defined for SBFD and non-SBFD symbol types in the second configuration configured to the UE in step S402. For example, the second configuration may cause the UE to report CSI parameters in slot n, and the CSI report configuration configured in the second configuration comprises two sub-configurations, for SBFD and non-SBFD symbol types. In such configuration, CSI reference resource can be defined at sub-configuration level. For instance, the CSI reference signal1 is defined for SBFD symbol type and CSI reference signal2 is defined for non-SBFD symbol type. In such an instance, if the UE receives at least one CSI-RS transmission occasion before CSI reference signal1 and the occasion falls in SBFD symbol, then the UE is configured to measure parameters for SBFD using the CSI-RS transmission occasion and report it to the BS in slot n. Similarly reporting is performed for CSI reference signal2 and CSI-RS transmission occasion for non-SBFD symbol.

Hence, the UE is configured to perform CSI reporting only if at least one CSI-RS corresponding to at least one of SBFD time resource or non-SBFD time resource is received before CSI reference resource. That is, the UE is configured to transmit the CSI report only when at least one of CSI-RS for non-SBFD time resource or CSI-RS for SBFD time resource is received before a first CSI reference resource or a second CSI reference resource respectively, wherein the first CSI reference signal is configured in the second configuration for non-SBFD time resource and the second CSI reference signal is configured in the second configuration for SBFD time resource.

Configuring time restriction for measurement, in second configuration, is to indicate to the UE, whether to measure the CSI parameter using most recent CSI-RS resource before CSI reference resource or to measure a CSI parameter using multiple CSI-RS resources and report an average value. In case of SBFD, various scenarios arises and UE behaviour need to be defined for each scenario. If the CSI report configuration is common for SBFD and non-SBFD and time restriction is configured, then the UE measures first CSI parameter using most recent CSI resource in SBFD symbol and a second CSI parameter using most recent CSI resource non-SBFD symbol. If CSI report configuration is for SBFD symbols and time restriction is configured in the second configuration, then the UE measures the CSI parameters based on the most recent CSI resource in SBFD symbol. If CSI report configuration is for non-SBFD symbols and time restriction is configured in the second configuration, then the UE measures the CSI parameters based on the most recent CSI resource in non-SBFD symbol. Different options are configured or defined to the UE to be performed in such a scenario.

A first option configured to the UE for the first scenario involves deriving the channel measurements for computing CSI reported in uplink slot n based on only the most recent occasion of NZP CSI-RS, no later than the CSI reference resource and configured for SBFD operation if the higher layer parameter timeRestrictionForChannelMeasurements in CSI-ReportConfig is set to “Configured” and if “reporttype” or “subconfigurationtype” is set to “SBFD”.

A second option configured to the UE for the first scenario involves deriving the channel measurements for computing CSI reported in uplink slot n based on only the most recent occasion of NZP CSI-RS, no later than the CSI reference resource and configured for non-SBFD operation if the higher layer parameter timeRestrictionForChannelMeasurements in CSI-ReportConfig is set to “Configured” and if “reporttype” or “subconfigurationtype” is set to “non-SBFD”.

A third option configured to the UE for the first scenario involves deriving the set of channel measurements for computing CSI reported in uplink slot n, based on only the most recent occasion of NZP CSI-RS, no later than the CSI reference resource and configured for SBFD operation if the higher layer parameter timeRestrictionForChannelMeasurements in CSI-ReportConfig is set to “Configured” and if “reporttype” or “subconfigurationtype” is set to “both SBFD and non-SBFD”.

A fourth option configured to the UE for the first scenario involves deriving the set of channel measurements for computing CSI reported in uplink slot n, based on only the most recent occasion of NZP CSI-RS, no later than the CSI reference resource and configured for non-SBFD operation if the higher layer parameter timeRestrictionForChannelMeasurements in CSI-ReportConfig is set to “Configured” and if “reporttype” or “subconfigurationtype” is set to “both SBFD and non-SBFD”.

A fifth option configured to the UE for the first scenario involves deriving the set of channel measurements for computing CSI reported in uplink slot n, based on only the most recent occasion of NZP CSI-RS, no later than the CSI reference resource if the higher layer parameter timeRestrictionForChannelMeasurements in CSI-ReportConfig is set to “Configured” and if “reporttype” or “subconfigurationtype” is set to “both SBFD and non-SBFD”. In such an option, if the most recent occasion corresponds to SBFD then the UE measures only CSI parameters for SBFD and report it to BS. Alternatively, if the most recent occasion corresponds to non-SBFD then UE measures only CSI parameters for non-SBFD and report it to BS.

A sixth option configured to the UE for the first scenario involves deriving the two set of channel measurements for computing CSI reported in uplink slot n, one based on only the most recent occasion of NZP CSI-RS, no later than the CSI reference resource and configured for non-SBFD operation and second one based on only the most recent occasion of NZP CSI-RS, no later than the CSI reference resource and configured for non-SBFD operation if the higher layer parameter timeRestrictionForChannelMeasurements in CSI-ReportConfig is set to “Configured” and if “reporttype” or “subconfigurationtype” is set to “both SBFD and non-SBFD”.

The UE is configured to adopt the above-mentioned options for the first scenario corresponds to deriving of channel measurement. The same options are adopted by the UE with respect to measurement of inference during CSI measurement

In a second scenario, the UE may be configured with a fixed or defined behaviour. In one embodiment, the fixed behaviour configured for the UE based on the second configuration may be the evaluation of CSI parameters based on the most recent CSI resource before CSI reference resource in SBFD/non-SBFD symbol if time restriction is configured. The UE may be configured to adopt different options corresponding to the second scenario.

A first option configured to the UE for the second scenario involves deriving the channel measurements for computing CSI reported in uplink slot n based on only the most recent occasion of NZP CSI-RS, no later than the CSI reference resource and configured for SBFD operation if the higher layer parameter timeRestrictionForChannelMeasurements in CSI-ReportConfig is set to “Configured”.

A second option configured to the UE for the second scenario involves deriving the channel measurements for computing CSI reported in uplink slot n based on only the most recent occasion of NZP CSI-RS, no later than the CSI reference resource and configured for non-SBFD operation if the higher layer parameter timeRestrictionForChannelMeasurements in CSI-ReportConfig is set to “Configured”.

A third option configured to the UE for second scenario involves deriving the interference measurements for computing the CSI value reported in uplink slot n based on the most recent occasion of CSI-IM and/or NZP CSI-RS for interference measurement, no later than the CSI reference resource and configured for SBFD operation if the higher layer parameter timeRestrictionForInterferenceMeasurements in CSI-ReportConfig is set to “Configured”.

A fourth option configured to the UE for the second scenario involves deriving the interference measurements for computing the CSI value reported in uplink slot n based on the most recent occasion of CSI-IM and/or NZP CSI-RS for interference measurement, no later than the CSI reference resource and configured for non-SBFD operation if the higher layer parameter timeRestrictionForInterferenceMeasurements in CSI-ReportConfig is set to “Configured”.

In certain embodiments, the configuring of second configuration is done such that it comprises a first CSI reference resource for SBFD time resource, and a second CSI reference resource for a non-SBFD time resource. In certain embodiments, the second configuration also includes a time restriction for non-SBFD time resource and a time restriction for non-SBFD time resource. In certain embodiments, the second configuration is configured by the BS such that it comprises a type of the time restriction as either or both of SBFD and non-SBFD.

In certain embodiments, the configuring of the second configuration by the BS also includes configuring the UE with the CSI parameter to report under a CSI report using information element reportQuantity in CSI-ReportConfig. Different groups of report quantities are defined in

NR and one of the groups is indicated to UE in reportQuantity. For instance, if reportQuantity=‘cri-RI-CQI’, then the UE has to report CSI-RS resource index, the rank and the channel quality, where the CSI-RS resource index corresponds to the CSI-RS resource on which the rank and channel quality values are measured.

In case of configuring separate resources for measuring parameters for SBFD and non-SBFD, and when the UE is configured to report CRI and other CSI parameters, then the UE is also configured by the second configuration to measure and report CRI and other configured CSI parameters separately for SBFD and non-SBFD symbols. The CSI parameters reported for SBFD symbol will be conditioned on the CRI corresponding to SBFD symbol and CSI parameters reported for non-SBFD symbol will be conditioned on the CRI corresponding to non-SBFD symbol, by the second configuration. If UE is configured with separate CSI resources for SBFD and non-SBFD symbols, then the second configuration configures that the sCRI k reported for SBFD symbol will be (k+1)th entry in the CSI-RS resource set associated with SBFD symbol. Similarly, second configuration configures that the CRI p is reported for non-SBFD symbol will be (p+1)th entry in the CSI-RS resource set associated with non-SBFD symbol.

The configuring with CSI parameters included in the second configuration involves configuring the UE to derive the CSI parameters other than CRI conditioned on the reported CRI, where CRI k (k≥0) corresponds to the configured (k+1)-th entry of associated nzp-CSI-RS-Resources in the corresponding NZP-CSI-RS-ResourceSet for channel measurement, and (k+1)-th entry of associated csi-IM-Resource in the corresponding csi-IM-ResourceSet (if configured) or (k+1)-th entry of associated nzp-CSI-RS-Resources in the corresponding NZP-CSI-RS-ResourceSet (if configured for CSIReportConfig with reportQuantity set to ‘cri-SINR’ or ‘cri-SINR-Index’) for interference measurement, if the UE is configured with a CSI-ReportConfig with the higher layer parameter reportQuantity set to ‘cri-RSRP’, ‘cri-RI-PMI-CQI’, ‘cri-RI-i1’, ‘cri-RI-i1-CQI’, ‘cri-RI-CQI’, ‘cri-RI-LI-PMI-CQI’, ‘cri-SINR’, or ‘cri-SINR-Index’, and more than one resources are configured in the corresponding resource set for channel measurement,

The configuring included in the second configuration further involves configuring the CRI k (k≥0) to correspond to the configured (k+1)-th entry of associated nzp-CSI-RS-Resources in the corresponding NZP-CSI-RS-ResourceSet for channel measurement in SBFD symbol, and (k+1)-th entry of associated csi-IM-Resource in the corresponding csi-IM-ResourceSet (if configured) for SBFD symbol or (k+1)-th entry of associated nzp-CSI-RS-Resources in the corresponding NZP-CSI-RS-ResourceSet (if configured for CSIReportConfig with reportQuantity set to ‘cri-SINR’ or ‘cri-SINR-Index’) for interference measurement in SBFD symbol, in case the UE is configured with separate resource set for measuring CSI parameters for SBFD symbols.

Step S403 of the proposed method performed by the BS involves performing of transmission and/or reception of a signal or a channel. The transmission and/or reception performed by the BS in step S403 also includes the transmission of the first and second configuration configured by the BS in step S401 and S402 to a UE, which may thereafter be used by the UE for CSI measurement and reporting corresponding to SBFD and non-SBFD operations. The performing of reception in step S403 includes receiving of a CSI report, where the CSI report is transmitted by a UE after performing CSI measurement and reporting based on the first and second configurations defined by the BS. The reception is performed by the BS in at least one of RRC, DCI, and MAC-CE.

The CSI report received by the BS in step S403 comprises at least one of at least one first CSI quantity for SBFD time resource and at least one second CSI quantity for non-SBFD time resource, wherein the first CSI quantity and second CSI quantity are obtained based on measurements performed by the UE based on the first and second configuration. The at least one first CSI quantity for SBFD time resource further comprises an index of at least one first CSI-RS, and the at least one second CSI quantity for non-SBFD time resource further comprises an index of at least one second CSI-RS.

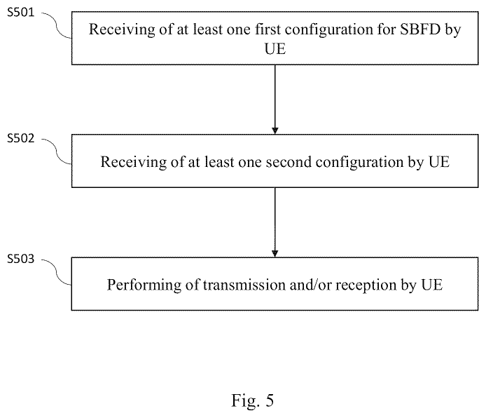

In a second embodiment of the present invention, the proposed method may be performed by a second node such as a UE a mobile terminal (MT) for performing transmission and/or reception of a signal or a channel. FIG. 5 illustrates a flowchart of steps of the proposed method executed by a UE, in accordance with an embodiment of the present invention. Step S501 of the proposed method executed by the UE involves receiving of a first configuration. The first configuration is received from a BS, and is configured by the BS to comprise different resources essential to SBFD operation. In an embodiment, the first configuration configured by the BS to the UE comprises one or more SBFD time resources, wherein SBFD time resources relates to time resources where SBFD operation is to be enabled. The time resources referred to herein contains at least a symbol, and a type of the symbol, and a valid symbol type may be one of SBFD time resource and non-SBFD time resource.

Step S502 involves receiving of at least one second configuration configure by the BS. The second configuration received by the UE relates to transmission and/or reception of a signal and/or a channel, wherein an indication comprised in the second configuration may be used by the UE for determining whether the transmission and/or reception is to be performed in either one or both of SBFD time resources and non-SBFD time resources.

The second configuration received by the UE at step S502 may also include a scheduling information which may be used by the UE for the performing of transmission and/or reception of at least one signal and/or at least one channel. Herein, the transmission and/or reception of the at least one signal and/or the at least one channel may be performed in at least one scheduled SBFD time resource and/or at least one scheduled non-SBFD time resource. The at least one scheduled SBFD time resources and the at least one scheduled non-SBFD time resources are determined based on the scheduling information received in the second configuration.

The second configuration received by the UE at step S402 may also include either a single report configuration or separate report configurations for performing separate reporting of SBFD operation and non-SBFD operation. Here, an at least one first CSI report configuration in the second configuration received by UE corresponds to either the single report configuration, or a first report configuration of the separate report configurations. In case separate report configurations, an at least one second CSI report configuration included in the second configuration received by the UE corresponds to a second report configuration of the separate report configurations.

If separate report configurations are comprised in the second configuration received by the UE, such a second configuration may include one or more different configurations defined by the BS for identifying if the CSI report configurations included therein relates to SBFD operation or non-SBFD operation. In certain cases, a first type of configuration, included in the second configuration defined by the BS relates to a type field indicating to the UE the type of operation (i.e., SBFD or non-SBFD operations) for which the CSI report configurations are created. In certain cases, a second type of configuration included in the second configuration by the BS relates to a report quantity defined for SBFD time resource relates to report quantity defined for SBFD time resource. If a first or second CSI report configuration of the second configuration comprises such a configuration relating to a new report quantity for SBFD scenario, then the report is for SBFD scenario. If the UE receives a second configuration with such a configuration, it will perform measurement and reporting based on the corresponding report configuration is performed only in SBFD symbols.

In certain instances, a third type of configuration may be comprised in the second configuration defined by the BS and received by the UE, wherein the third configuration type of configuration relates to a type of the quantity that is to be measured and reported. Hence, the type of quantity is used by the UE for performing the measurement and reporting along with CSI report configuration. A fourth type of configuration that may be included in the second configuration, received by the UE, relates to a type of the resource set associated with report configuration. The type of the resource set indicated by the second configuration may be used by the UE for performing measuring and reporting of the CSI report. The type of the resource set is used by the UE to differentiate whether the report configuration is for SBFD scenario or non-SBFD scenario

If single report configurations are comprised in the second configuration received by the UE, such a second configuration may include one or more different types of configurations defined by the BS for identifying if the first CSI report configuration (i.e., single report configuration) included therein relates to SBFD operation or non-SBFD operation. A first type of configuration included in the second configuration relates to a new report quantity defined for SBFD. A second type of configuration that may be included in the second configuration received by the UE relates to a new format, wherein the new format can be specified for report quantity in report configuration. This method is useful when SBFD has impact only on certain CSI parameters alone.

A third type of configuration that may be comprised in the second configuration received by the UE relates to a type of resource set. The type of the resource set, comprised within can be used by the UE to differentiate whether to report parameters for SBFD scenario, non-SBFD scenario or both. A third type of configuration that may be comprised in the second configuration received by the UE relates to a type of resource. The type of resource set can be used by the UE to differentiate whether to report parameters mentioned in the report for SBFD scenario, non-SBFD scenario or both.

A fifth type of configuration that may be comprised in the second configuration received by the UE relates to multiple sub-configurations, where one set of sub-configurations corresponds to SBFD and second set of sub-configurations corresponds to non-SBFD. Such a type of configuration may include one or more of further configurations corresponding to each sub=-configuration, where the one or more further configuration include elements such as subconfiguration ID and subconfigurationtype, which can be configured as SBFD or non-SBFD, a new report quantity defined for SBFD and can be indicated in the sub-configuration, type of report quantity can be configured to the UE along with sub-configuration, and a type of resource set associated with sub-configuration to differentiate whether the sub-configuration is for SBFD scenario or non-SBFD scenario. Such further configurations with respect to each sub-configuration may be used by the UE to differentiate between SBFD and non-SBFD scenarios.

In case of periodic CSI reporting, if the first CSI report configuration of the second configuration received by the UE contains sub-configurations corresponding to SBFD and non-SBFD scenario, then the UE computes CSI parameters for SBFD and non-SBFD scenario separately based on the first CSI report configuration, and report it to the BS. Further, in case of semi-persistent or aperiodic CSI reporting, one of the sub-configurations can be activated by trigger signal.

The second configuration received by the UE in step S502 further comprises configuration relating to the CSI-RS resources required by the UE for performing CSI measurement and reporting corresponding to SBFD operation and non-SBFD operation. The configuring of the second configuration received by the UE indicates to the UE whether to report CSI parameters for non-SBFD scenario, SBFD scenario, both, or the existing manner of CSI reporting using the report configuration. Additionally, the second configuration may also comprise configuration relating to separate resources for measuring parameters for SBFD scenario and non-SBFD scenarios. The periodicity and offset of the CSI resources may be configured in the second configuration such that the CSI resources are transmitted only in SBFD scenario or in SBFD symbols.

The second configuration received by the UE thereby comprises at least one first resource set, wherein the first resource set may be used by the UE measurement and reporting of either an SBFD operation or a non-SBFD operation, corresponding to scenarios where CSI reporting corresponding to either SBFD operation and non-SBFD operation is to be performed. The second configuration may also comprise at least one second resource set, corresponding to scenarios where CSI reporting corresponding to both SBFD operation and non-SBFD operation is to be performed by the UE. In such instances, the second resource set CSI reporting corresponding to SBFD operation if the first resource set is used for non-SBFD operation, or vice-versa.

The second configuration may also include a configuring of a type field for indicating to the UE whether the resource sets relate to SBFD operation or non-SBFD operation, where the type field maps a resource set to SBFD operation or non-SBFD operation. Further, the second configuration further comprises at least one periodic CSI-RS resource and at least one semi-persistent CSI-RS resource.

In case of separate CSI report configuration for SBFD and non-SBFD configured in the second configuration received by the UE, the report configuration for SBFD scenario (i.e., either the first CSI report configuration or the second CSI report configuration) will be associated with set of CSI resources which maps to SBFD occasion. Similarly, the report configuration for non-SBFD scenario (i.e., either the first CSI report configuration if the second CSI report configuration is associated SBFD, or the second CSI report configuration if the first CSI report configuration is associated with SBFD) is associated with set of resources mapping to non-SBFD occasion.

Such mapping may be used by the UE to differentiate CSI resource set for SBFD scenario and non-SBFD scenario. For example, the resource set linking to CSI report configuration corresponding to SBFD scenario is considered as CSI resources corresponding to SBFD scenario, and may be used by the UE for CSI measurement and reporting corresponding to SBFD operation. In an embodiment, a first resource set and a second resource set configured in the second configuration received by the UE, relating to CSI-RS resources configured for SBFD operation and non-SBFD operation, are CSI-RS for downlink transmissions and SRS (Sounding Reference Signal) for uplink transmission.

In the case of single CSI report configuration for SBFD and non-SBFD configured in the second configuration received by the UE, the same report configuration will be associated with more than one set of CSI resources, where a first set contains resources mapping to SBFD scenario and a second set of resources contains mapping to non-SBFD scenario. New IEs may be defined in the resource set configuration to indicate whether the resources within the resource set corresponds to SBFD scenario or non-SBFD scenario. The UE performs CSI measurement and reporting for the SBFD scenario and non-SBFD scenarios based on indicated provided by the newly defined IEs.

In certain embodiment, the second configuration received by the UE in step S502 contains configuring of CSI-RS resources and resource sets without considering the mapping to SBFD and non-SBFD scenario. In such an embodiment, the explicit indication about whether resource belongs to SBFD scenario or non-SBFD scenario is not available to the UE, and hence the UE determines the resources within resource set corresponding to SBFD and non-SBFD scenario based on the information about SBFD parameters. In the embodiment, the second configuration may indicate the subband for SBFD operation and the time instances where the subband is active to the UE. The CSI-RS resources mapping to time and frequency resources overlapping with SBFD resources is treated by the UE as CSI-RS resources corresponding to SBFD scenario and vice versa.

In this case, the CSI report configuration can link to resource set comprising CSI-RS resources for SBFD and non-SBFD scenario. The UE determines the resources within resource set corresponding to SBFD based on the information about SBFD parameters, measure the parameters indicated by report configuration and report the parameter to the BS. Similar is the case with non-SBFD operation scenario.

The CSI-RS resources configured by the BS in the second configuration for CSI measurement and reporting may be indicated to the UE as a trigger signal. The trigger signal is transmitted activation of CSI reporting by the UE, following which the UE may perform CSI reporting based on the second configuration. UE may determine whether to measure the CSI parameters in SBFD resource, non-SBFD resource or both based on an indication provided in the trigger signal. For example, a new field can be indicated in DCI, triggering an aperiodic CSI reporting which can be configured as {SBFD alone, non-SBFD or both}. If the DCI triggering aperiodic reporting indicates Reportype=SBFD, then the UE determines CSI-RS resources corresponding to SBFD scenario, based on BS configuration or based on parameters configured for SBFD, measure the parameters and report to BS. Similar is the case if DCI triggering indicate report type as non-SBFD. Similar fields can be introduced in MAC_CE triggering semi-persistent CSI reporting as well.

The configuration of the trigger signal included in the second configuration received at the UE may be such that the trigger signal, in addition to activating the CSI reporting, also activated at least one of at least one sub-configuration, at least one CSI report configuration, and at least one second CSI report configuration defined in the second configuration. The trigger for activation of at least one sub-configuration is configured by the BS in scenarios where one or more sub-configurations corresponding to a single report configuration is configured in the second configuration by the BS. The trigger for activation of at least a first CSI report configuration is configured by the BS for activating a single report configuration for separate reporting of SBFD and non-SBFD operations.

The trigger for activation of at least a second CSI report configuration is configured by BS when separate report configurations are defined by the BS for reporting relating to SBFD and non-SBFD operation. In such an instance, if the first CSI report configuration is associated with SBFD operation, then the second CSI report configuration is associated with non-SBFD operation, or vice versa. In certain embodiment, the trigger signal configured by the BS may further comprise an indicator to at least one of at least one sub-configuration, at least one CSI report configuration, and at least one second CSI report configurations, for the purpose of activating such configurations.

The second configuration received by the UE in step S502 further a valid symbol type configured for CSI derivation. The valid symbol type may be one of an SBFD time resource or a non-SBFD time resource, or may be both SBFD and non-SBFD time resource. The second configuration received by the UE also includes configurations relating to a CSI reference resource, and a time restriction for measurement of CSI parameters/quantities. The CSI reference resource CSI reference resource is the minimum time duration, from the CSI reporting time, before which a CSI-RS resource need to be received at the UE so that the UE measure CSI parameters based on the CSI-RS resource and include it in the CSI report. The time restriction for measurement is configured to the UE to avoid averaging of the parameters based on multiple CSI resources.

In certain embodiments, the second configuration comprises a first CSI reference resource for SBFD time resource, and a second CSI reference resource for a non-SBFD time resource. In certain embodiments, the second configuration also comprises a time restriction for non-SBFD time resource and a time restriction for non-SBFD time resource. In certain embodiments, the second configuration is configured by the BS such that it comprises a type of the time restriction as either or both of SBFD and non-SBFD.

Step S503 of the proposed method performed by the UE involves performing of transmission and/or reception of a signal or a channel. The transmission and/or reception is performed by the UE in either one or both of the at least one second SBFD time resource and the at least one second non-SBFD time resource based on the first configuration and the second configuration received by the BS in steps S501 and S502. The transmission and/or reception of at least one signal or at least one channel by the UE in step S503 is based on the reporting of the CSI report generated by the UE to the BS, and channel estimation performed by the BS based on the CSI report.

Hence, the transmission and/or reception of the at least one signal or the at least one channel performed in step S503 includes the CSI measurement and reporting performed by the UE based on the first configuration and the second configuration received at steps S501 and S502 respectively. The reception performed at step S503 includes the measuring of at least one first CSI quantity in the non-SBFD time resource using at least one CSI-RS and measuring of at least one second CSI quantity in the SBFD time resource using at least one CSI-RS, wherein the measurement of the first CSI quantity and the second CSI quantity is based on the first configuration and the second configuration, and the CSI-RS resources used for the measurement are configured in the second configuration.

The at least first CSI quantity and the at least second CSI quantity are measured by the UE for reporting corresponding to the non-SBFD scenario and SBFD scenario respectively, and the reporting of the quantities constitute a transmission within step S503, where such reporting is performed based on at least a first CSI reporting configuration obtained from the second configuration. The reporting of the at least two CSI reports comprising the at least first CSI quantity and the at least second CSI quantity respectively is performed by the UE based on the CSI-RS received in SBFD and non-SBFD symbol in step S503 such that the report comprises an index of the CSI-RS. Such reporting is performed by the UE based on corresponding configuration in the second configuration, where the UE is configured with the CSI parameter to report under a CSI report using information element reportQuantity in CSI-ReportConfig. For example, if reportQuantity=‘cri-RI-CQI’, then the UE has to report CSI-RS resource index, the rank and the channel quality, where the CSI-RS resource index corresponds to the CSI-RS resource on which the rank and channel quality values are measured.

In case of separate resources for measuring parameters for SBFD and non-SBFD, and when the UE is configured to report CRI and other CSI parameters, then the UE measures and reports CRI and other configured CSI parameters separately for SBFD and non-SBFD symbols. The CSI parameters reported for SBFD symbol will be conditioned on the CRI corresponding to SBFD symbol and CSI parameters reported for non-SBFD symbol will be conditioned on the CRI corresponding to non-SBFD symbol. If UE is configured with separate CSI resources for SBFD and non-SBFD symbols, then CRI k reported for SBFD symbol will be (k+1)th entry in the CSI-RS resource set associated with SBFD symbol. Similarly, CRI p reported for non-SBFD symbol will be (p+1)th entry in the CSI-RS resource set associated with non-SBFD symbol.

The reporting of the at least first CSI quantity and the at least second CSI quantity is also conditional to several cases that may occur in the reporting by UE corresponding to receipt of CSI reference resources for non-SBFD and SBFD symbols, and receipt of CSI-RS. The CSI-RS may include at least one CSI-RS transmission occasion for channel measurement and CSI-RS and/or CSI-IM occasion for interference measurement. Further, CSI reference resource may be configured in the second configuration corresponding to either both SBFD time resource or non-SBFD time resource, or may be configured in the second configuration to as a first CSI reference resource for non-SBFD time resources and as a second CSI reference resource for SBFD time resources.

In a first scenario, the UE may receive at least one CSI-RS before the CSI reference resource, for both non-SBFD and SBFD symbols. In such a case, the UE transmits a CSI report, containing CSI parameters corresponding to SBFD and non-SBFD scenario, to the BS based on the CSI report configuration. In a second scenario, the UE may not receive in either SBFD symbol or non-SBFD symbol at least one CSI-RS before CSI reference resource. In such a case the UE will drop the entire CS report.

In a third scenario, the UE may receive in non-SBFD symbol at least one CSI-RS before CSI reference resource and not receive in SBFD symbol at least one CSI-RS. In such a case, one option that may be adopted by the UE is to transmit CSI report containing CSI parameters corresponding to non-SBFD scenario to the BS based on the CSI report configuration, where the CSI report configuration is obtained from the second configuration received by the UE in step S502. Another option that may be adopted by the UE is to drop the entire CSI report. Yet another option that may be adopted by the UE is to transmit a complete CSI report based on CSI report configuration, obtained from the second configuration. In such an option, the UE derives the CSI parameters for SBFD scenario based on the CSI-RS resource in non-SBFD symbol.

In a fourth scenario, the UE may receive in SBFD symbol at least one CSI-RS before CSI reference resource and not receiving in non-SBFD symbol at least one CSI-RS in non-SBFD symbol. In such a case, one option adopted by the UE may be to transmit CSI report CSI parameter corresponding to SBFD scenario to the BS based on the CSI report configuration obtained from the second configuration. Another option that may be adopted by the UE may be to drop the entire CSI report. Yet another option adopted by the UE may be to transmit the complete CSI report based on CSI report configuration obtained from the second configuration received by the UE. The UE derives the CSI parameters for non-SBFD scenario based the CSI-RS resource received in SBFD symbol.

In a fifth scenario, separate CSI reference resources may be defined for SBFD and non-SBFD symbol types in the second configuration received by the UE in step S502. For example, the second configuration may cause the UE to report CSI parameters in slot n, and the CSI report configuration configured in the second configuration comprises two sub-configurations, for SBFD and non-SBFD symbol types. In such configuration, CSI reference resource can be defined at sub-configuration level. For instance, the CSI reference signal1 is defined for SBFD symbol type and CSI reference signal2 is defined for non-SBFD symbol type. In such an instance, if the UE receives at least one CSI-RS transmission occasion before CSI reference signal1 and the occasion falls in SBFD symbol, then the UE measure parameters for SBFD using the CSI-RS transmission occasion and report it to the BS in slot n. Similarly reporting is performed for CSI reference signal2 and CSI-RS transmission occasion for non-SBFD symbol.

Hence, the UE performs CSI reporting only if at least one CSI-RS corresponding to at least one of SBFD time resource or non-SBFD time resource is received before CSI reference resource. That is, a CSI report is transmitted by the UE in step S503 only when at least one of CSI-RS for non-SBFD time resource or CSI-RS for SBFD time resource is received before a first CSI reference resource or a second CSI reference resource respectively, wherein the first CSI reference signal is configured in the second configuration for non-SBFD time resource and the second CSI reference signal is configured in the second configuration for SBFD time resource.

In the case of SBFD enabled network, the CSI-RS resources can fall in SBFD and non-SBFD resources and the measurements can be different in SBFD and non-SBFD scenarios. Further, the CSI measurements in SBFD symbol may not be accurate as measurements in non-SBFD symbols. Hence, along with time restriction, the second configuration received by the UE also includes a configuration of the symbol type of the last CSI resource. The performing of measurement and reporting by the UE in step S503 is hence also based on the receiving the symbol type of the last CSI resource before the CSI reference signal, corresponding to one or more different scenarios.

In one scenario, a behaviour of the UE, i.e., whether to consider most recent CSI resource or most recent CSI resource in SBFD symbol or most recent CSI resource non-SBFD symbol, when a higher layer parameter time restriction in CSI-ReportConfig is set to “Configured” in the second configuration received by the UE. If CSI report configuration is for SBFD symbols and time restriction is configured in the second configuration, then the UE evaluates the CSI parameters based on the most recent CSI resource in SBFD symbol. Different options are adopted by the UE in such a scenario.

A first option adopted by the UE for the first scenario involves deriving the channel measurements for computing CSI reported in uplink slot n based on only the most recent occasion of NZP CSI-RS, no later than the CSI reference resource and configured for SBFD operation if the higher layer parameter timeRestrictionForChannelMeasurements in CSI-ReportConfig is set to “Configured” and if “reporttype” or “subconfigurationtype” is set to “SBFD”.

A second option adopted by the UE for the first scenario involves deriving the channel measurements for computing CSI reported in uplink slot n based on only the most recent occasion of NZP CSI-RS, no later than the CSI reference resource and configured for non-SBFD operation if the higher layer parameter timeRestrictionForChannelMeasurements in CSI-ReportConfig is set to “Configured” and if “reporttype” or “subconfigurationtype” is set to “non-SBFD”.

A third option adopted by the UE for the first scenario involves deriving the set of channel measurements for computing CSI reported in uplink slot n, based on only the most recent occasion of NZP CSI-RS, no later than the CSI reference resource and configured for SBFD operation if the higher layer parameter timeRestrictionForChannelMeasurements in CSI-ReportConfig is set to “Configured” and if “reporttype” or “subconfigurationtype” is set to “both SBFD and non-SBFD”.

A fourth option adopted by the UE for the first scenario involves deriving the set of channel measurements for computing CSI reported in uplink slot n, based on only the most recent occasion of NZP CSI-RS, no later than the CSI reference resource and configured for non-SBFD operation if the higher layer parameter timeRestrictionForChannelMeasurements in CSI-ReportConfig is set to “Configured” and if “reporttype” or “subconfigurationtype” is set to “both SBFD and non-SBFD”.

A fifth option adopted by the UE for the first scenario involves deriving the set of channel measurements for computing CSI reported in uplink slot n, based on only the most recent occasion of NZP CSI-RS, no later than the CSI reference resource if the higher layer parameter timeRestrictionForChannelMeasurements in CSI-ReportConfig is set to “Configured” and if “reporttype” or “subconfigurationtype” is set to “both SBFD and non-SBFD”. In such an option, if the most recent occasion corresponds to SBFD then the UE measures only CSI parameters for SBFD and report it to BS. Alternatively, if the most recent occasion corresponds to non-SBFD then UE measures only CSI parameters for non-SBFD and report it to BS.

A sixth option adopted by the UE for the first scenario involves deriving the two set of channel measurements for computing CSI reported in uplink slot n, one based on only the most recent occasion of NZP CSI-RS, no later than the CSI reference resource and configured for non-SBFD operation and second one based on only the most recent occasion of NZP CSI-RS, no later than the CSI reference resource and configured for non-SBFD operation if the higher layer parameter timeRestrictionForChannelMeasurements in CSI-ReportConfig is set to “Configured” and if “reporttype” or “subconfigurationtype” is set to “both SBFD and non-SBFD”.

The above-mentioned options adopted by the UE for the first scenario corresponds to deriving of channel measurement. The same options are adopted by the UE with respect to measurement of inference during CSI measurement.

In a second scenario, the UE has a fixed or defined behaviour. In one embodiment, the fixed behaviour of UE may be the evaluation of CSI parameters based on the most recent CSI resource before CSI reference resource in SBFD/non-SBFD symbol if time restriction is configured. Different options are adopted by the UE corresponding to the second scenario.

A first option adopted by the UE for the second scenario involves deriving the channel measurements for computing CSI reported in uplink slot n based on only the most recent occasion of NZP CSI-RS, no later than the CSI reference resource and configured for SBFD operation if the higher layer parameter timeRestrictionForChannelMeasurements in CSI-ReportConfig is set to “Configured”.

A second option adopted by the UE for the second scenario involves deriving the channel measurements for computing CSI reported in uplink slot n based on only the most recent occasion of NZP CSI-RS, no later than the CSI reference resource and configured for non-SBFD operation if the higher layer parameter timeRestrictionForChannelMeasurements in CSI-ReportConfig is set to “Configured”.

A third option adopted by the UE for second scenario involves deriving the interference measurements for computing the CSI value reported in uplink slot n based on the most recent occasion of CSI-IM and/or NZP CSI-RS for interference measurement, no later than the CSI reference resource and configured for SBFD operation if the higher layer parameter timeRestrictionForInterferenceMeasurements in CSI-ReportConfig is set to “Configured”.

A fourth option adopted by the UE for the second scenario involves deriving the interference measurements for computing the CSI value reported in uplink slot n based on the most recent occasion of CSI-IM and/or NZP CSI-RS for interference measurement, no later than the CSI reference resource and configured for non-SBFD operation if the higher layer parameter timeRestrictionForInterferenceMeasurements in CSI-ReportConfig is set to “Configured”.

The channel measurements and the interference measurements are performed by the UE for using at least one of SBFD time resources and the non-SBFD time resource to obtain at least one of at least one first CSI quantity and at least one second CSI quantity, where the first CSI quantity relates to non-SBFD time resource and the second CSI quantity relates to SBFD time resource. The CSI report generated by the UE in step S503 comprises at least one of the at least one first CSI quantity and at least one second CSI quantity, and the transmission of step S503 include the transmission of the CSI report to the BS. The CSI report is transmitted to the BS by the UE based on the reporting configurations configured in the second configuration received by the UE in step S502. The reporting of the CSI report by the UE is activated based on a trigger signal configured in the second configuration, where the trigger signal comprises an indication relating to the report configuration to be used for reporting of the CSI report.

Hence, the transmissions performed in step S503 includes the transmission of CSI report to the BS after the performing of channel and interference measurement corresponding SBFD and/or non-SBFD scenarios, and the transmission of data to the BS following the channel estimation performed by the BS based on the CSI report. The receptions performed in step S503 includes the reception of the first configuration and second configuration configured by BS, and the reception of data from BS following the channel estimation performed by the BS based on the CSI report generated by the UE.

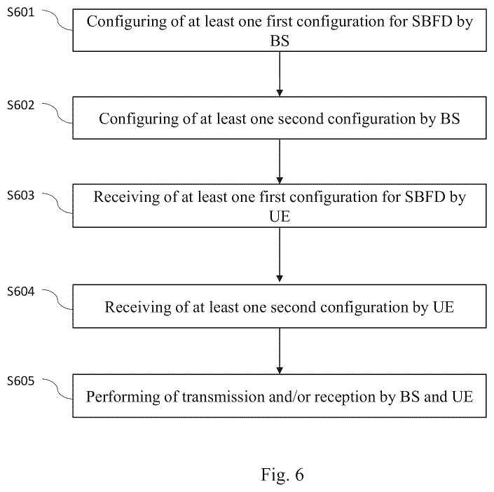

In one embodiment of the present invention, the proposed method may be performed using both the UE and BS for the transmission and reception of data, or at least one of a signal or a channel. The steps executed in such an embodiment is as illustrated in FIG. 6. Step S601 involves configuring of a first configuration by the BS, wherein the first configuration relates to configuring of different resources essential to SBFD operation, including at least one SBFD time resource. Step S602 involves configuring of the second configuration by the BS, wherein the second configuration relates to the different resources and configurations associated with transmission and/or reception of at least one of a signal or a channel.

The second configuration is configured so as to include an indication as to whether the transmission and/or reception is to be performed in either one or both of at least one SBFD time resource and at least one non-SBFD time resource. The second configuration further includes configuration relating to one or more report configurations corresponding to reporting of the CSI quantities of SBFD and non-SBFD scenarios separately. The report configuration may be a single report configuration or separate report configurations. The second configuration comprises configurations relating to the resource sets and the resources, and also includes a type field to indicate whether the resource set relates to SBFD scenario or non-SBFD scenario. The one or more resource sets configured in the second configuration are one of CSI-RS for downlink operations and SRS for uplink operations.

The second configuration further includes configurations relating to a trigger signal used for activating the CSI report, wherein the configuration involves an indication regarding the type of report configuration to be used for reporting the CSI report. The second configuration configured in step S602 further includes configuring of behaviour to be adopted by the UE during performing of channel and interference measurement. The steps to be adopted by UE during such CSI measurement is configured with respect to CSI reference resource and time restriction elements. The second configuration further includes one of at least one periodic CSI-RS resource and at least one semi-persistent CSI resource. The second configuration also includes a valid symbol type for CSI derivation, wherein the valid symbol is one of SBFD time resource, non-SBFD time resource, or both SBFD and non-SBFD time resource.

The step S603 involves receiving of the first configuration from the BS by the UE, and step S604 involves receiving of the second configuration from the BS by the UE. Step S605 involves the transmission and/or reception of a channel or a signal by the UE or the BS. The transmission and/or reception performed between the UE and the BS is based on performing of CSI measurement and reporting by the UE for SBFD scenario and/or non-SBFD scenario based on the first configuration and second configuration received from the BS.

The CSI measurement, involving channel and interference measurement, is performed by the UE to obtain one or both of at least a first CSI quantity and at least a second CSI quantity, wherein the first CSI quantity may relate to a CSI quantity obtained based on measurement in the SBFD time resource and second CSI quantity may relate to a CSI quantity obtained based on measurement in the non-SBFD time resource. The CSI measurement is performed by the UE based on configurations defined in the first configuration and the second configuration with regard to different scenarios associated with CSI reference resource and time restriction factors.

The CSI reporting is performed by the UE based on the second configuration received from the BS at step S604, and the receptions in step S604 includes the reception of the CSI report from the UE by the BS. The CSI report obtained by the BS may be used for channel estimation by the BS, based on which communication, constituted by further transmissions and receptions, may be performed in the wireless communication network between the UE and the BS.

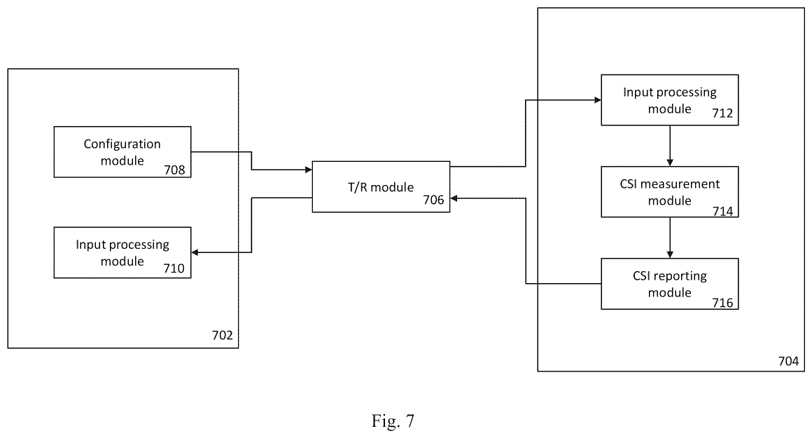

FIG. 7 illustrates an exemplary system for performing communication in a wireless network enabled with SBFD operation, in accordance with an embodiment of the present invention. The system 700 comprises BS node 702, a UE node 704, and a T/R (transmission/reception) module 706. The BS node 702 comprises a configuration module 708 for configuring the first configuration and the second configuration. The BS node 702 further comprises an input processing module 710 for processing of a CSI report generated by the UE node 704 based on the first configuration and the second configuration. The input processing module 710 may also be used for processing of data received by the BS node 702 from the UE node 704 during wireless communication performed based on enabling of SBFD in the wireless communication network.

The UE node 704 comprises a input processing module 712 for processing input received from the BS node 702. The inputs received include the first configuration and the second configuration, which may be processed by the input processing module 712 to obtain the different configurations comprised in the first and second configurations. Based on the processing of the first configuration and the second configuration by the input processing module 712, a CSI measurement module 714 may perform measurement of one or both of a first CSI quantity and a second quantity, wherein the first CSI quantity may be computed in the SBFD time resource and the second CSI quantity may be computed in the non-SBFD time resource.

The one or more CSI quantities measured by the CSI measurement module 714 may be reported to the BS node 702 by a CSI reporting module 716, wherein the reporting is done based on the second configuration received by the UE node 704. The transmissions and receptions are performed by the UE node 704 and the BS node 702 using a T/R module, and the types of transmission and/or receptions performed using the T/R module include the transmission of the first and second configuration by the BS node 702, the reception of the first and second configuration by the UE node 704, the transmission of a trigger signal, the transmission of the CSI report by the UE node 704, the reception of the CSI report by the BS node 702, and the transmission and reception of data between the UE node 704 and the BS node 702 based on channel estimation performed by the BS node 702 using the CSI report.

The figures of the disclosure are provided to illustrate some examples of the invention described. The figures are not to limit the scope of the depicted embodiments or the appended claims. Aspects of the disclosure are described herein with reference to the invention to example embodiments for illustration. It should be understood that specific details, relationships, and method are set forth to provide a full understanding of the example embodiments. One of ordinary skill in the art recognize the example embodiments can be practiced without one or more specific details and/or with other methods.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

What is claimed is:

1. A method for communication in a wireless communication network enabled with SBFD (Subband Full Duplex) operation, the method comprising:
configuring, by at least one first node, at least one first configuration for SBFD, wherein the at least one first configuration for SBFD comprises one or more SBFD time resources;
configuring, by at least one first node, at least one second configuration relating to at least one of transmission and reception of at least one of a signal and a channel, wherein the at least one second configuration comprises an indication to perform at least one of transmission and reception in at least one of SBFD time resources and non-SBFD time resources; and
performing, by the at least one first node, one of the transmission and the reception in at least one of at least one scheduled SBFD time resource and at least one scheduled non-SBFD time resource based on the at least one first configuration and the at least one second configuration.

2. The method as claimed in claim 1, wherein a time resource contains at least a symbol, wherein the time resource includes SBFD time resource and non-SBFD time resource.

3. The method as claimed in claim 1, wherein the at least one scheduled SBFD time resource is at least one of the one or more SBFD time resources, and the at least one scheduled non-SBFD time resource is at least one of the one or more non-SBFD time resources.

4. The method as claimed in claim 1, wherein at least one second configuration comprises scheduling information for performing at least one of the transmission and the reception of at least one of the at least one signal and the at least one channel.

5. The method as claimed in claims 1 and 4, wherein at least one of the at least one scheduled SBFD time resource and the at least one scheduled non-SBFD time resource is derived from scheduling information.

6. The method as claimed in claim 1, wherein the at least one second configuration comprises at least one of at least one first CSI report configuration and at least one second CSI report configuration.

7. The method as claimed in claim 6, wherein when a single report configuration is provided in the second configuration for reporting for SBFD time resources and non-SBFD time resources, the first CSI report configuration corresponds to the single report configuration.

8. The method as claimed in claim 6, wherein when separate report configurations are provided in the second configuration for reporting for SBFD time resources and non-SBFD time resources, the first CSI report configuration and the second CSI report configurations corresponds to a first report configuration and a second report configuration of the separate report configurations respectively.

9. The method as claimed in claim 6, wherein the at least one second configuration further comprises at least one of:
a. a type field to indicate one of SBFD and non-SBFD,
b. at least one report quantity for SBFD time resources,
c. an indication to measure at least one CSI parameter for SBFD time resources,
d. an indication to at least one resource set associated with SBFD time resources, and
e. at least one sub-configuration.

10. The method as claimed in claim 6, wherein the at least second configuration further comprises a valid symbol type for CSI derivation.

11. The method as claimed in claim 9, wherein the at least one sub-configuration comprises at least one of:
a. a sub-configuration type field to indicate one of SBFD and non-SBFD,
b. at least one report quantity for SBFD time resources,
c. an indication to measure at least one CSI parameter for SBFD time resources, and
d. an indication to at least one resource set associated with SBFD time resources.

12. The method as claimed in claim 6, further comprises transmitting a trigger signal to activate the CSI reporting.

13. The method as claimed in claim 12, wherein the trigger signal is used for activating at least one of:
a. at least one sub-configuration,
b. at least one first CSI report configuration, and
c. at least one second CSI report configuration.

14. The method as claimed in claim 6, wherein the trigger signal comprises at least one indicator to at least one of:
a. at least one sub-configuration,
b. at least one first CSI report configuration, and
c. at least one second CSI report configuration.

15. The method as claimed in claim 6, wherein the at least one second configuration further comprises at least one of:
a. a CSI reference resource,
b. a time restriction for measurement,
c. a first CSI reference resource for non-SBFD time resources,
d. a second CSI reference resource for SBFD time resources,
e. a time restriction for non-SBFD time resource,
f. a time restriction for SBFD time resources, and
g. type of the time restriction for measurement as at least one of SBFD and non-SBFD.

16. The method as claimed in claim 6, wherein the at least one second configuration further comprises one of
a. at least one periodic CSI-RS resource and
b. at least one semi-persistent CSI-RS resource.

17. The method as claimed in claim 10, wherein the valid symbol type is one of:
a. SBFD time resource,
b. non-SBFD time resource, and
c. both SBFD and non-SBFD time resource.

18. The method as claimed in claim 6, wherein the at least one second configuration comprises at least one of: at least one first resource set configuration and at least one second resource set configuration.

19. The method as claimed in claim 18, wherein the at least first resource set configuration and the at least second resource set configuration of the at least one second configuration further comprises a type field to indicate one of SBFD and non-SBFD.

20. The method as claimed in claim 18, wherein the first resource set and second resource set are one of:
a. channel state information reference signal (CSI-RS) for downlink, and
b. sounding reference signal (SRS) for uplink.

21. The method as claimed in claim 1, wherein performing the reception is receiving a CSI report.

22. The method as claimed in claim 21, wherein the CSI report comprises at least one of:
a. at least one first CSI quantity for SBFD time resources and index of at least one first CSI-RS, and
b. at least one second CSI quantity for non-SBFD time resources and index of at least one second CSI-RS.

23. The method as claimed in claim 22, wherein the at least one first CSI quantity is measured in the at least one first CSI-RS, and the at least one second CSI quantity is measured in the at least one second CSI-RS.

24. The method as claimed in claim 21, wherein reception is performed in at least one of RRC, DCI, and MAC-CE.

25. A method for communication in a wireless communication network enabled with SBFD (Subband Full Duplex) operation, the method comprising:
receiving, by at least one second node, at least one first configuration for SBFD, wherein the at least one first configuration for SBFD comprises one or more SBFD time resources;
receiving, by the at least the second node, at least one second configuration relating to at least one of transmission and reception of at least one of a signal and a channel, wherein the at least one second configuration comprises an indication to perform at least one of transmission and reception in at least one of SBFD time resources and non-SBFD time resources; and
performing, by the at least one second node, one of the transmission and the reception in at least one of at least one scheduled SBFD time resource and at least one scheduled non-SBFD time resource based on the at least one first configuration and the at least one second configuration.

26. The method as claimed in claim 25, wherein a time resource contains at least a symbol, wherein the time resource includes SBFD time resource and non-SBFD time resource.

27. The method as claimed in claim 25, wherein the at least one scheduled SBFD time resource is at least one of the one or more SBFD time resources, and the at least one scheduled non-SBFD time resource is at least one of one or more non-SBFD time resources.

28. The method as claimed in claim 25, wherein at least one second configuration comprises scheduling information for performing at least one of the transmission and the reception of at least one of the at least one signal and the at least one channel.

29. The method as claimed in claims 25 and 28, wherein at least one of the at least one scheduled SBFD time resource and the at least one scheduled non-SBFD time resource is derived from scheduling information.

30. The method as claimed in claim 25, wherein the at least one second configuration comprises at least one of at least one first CSI report configuration and at least one second CSI report configuration.

31. The method as claimed in claim 30, wherein when a single report configuration is provided in the second configuration for reporting for SBFD time resources and non-SBFD time resources, the first CSI report configuration corresponds to the single report configuration.

32. The method as claimed in claim 30, wherein when separate report configurations are provided in the second configuration for reporting for SBFD time resources and non-SBFD time resources, the first CSI report configuration and the second CSI report configurations corresponds to a first report configuration and a second report configuration of the separate report configurations respectively.

33. The method as claimed in claim 30, wherein the at least one second configuration further comprises a type field to indicate one of SBFD and non-SBFD.

34. The method as claimed in claim 30, wherein the at least one second configuration further comprises at least one of:
a. at least one report quantity for SBFD time resources,
b. an indication to measure at least one CSI parameter for SBFD time resources,
c. an indication to at least one resource set associated with SBFD time resources, and
d. at least one sub-configuration.

35. The method as claimed in claim 34, wherein the at least one sub-configuration comprises one of:
a. a sub-configuration type field to indicate one of SBFD and non-SBFD,
b. at least one report quantity for SBFD time resources,
c. an indication to measure at least one CSI parameter for SBFD time resources, and
d. an indication to at least one resource set associated with SBFD time resources.

36. The method as claimed in claim 30, further comprises receiving a trigger signal to activate the CSI reporting.

37. The method as claimed in claim 36, wherein receiving the trigger signal further comprises activating at least one of:
a. at least one sub-configuration,
b. at least one first CSI report configuration, and
c. at least one second CSI report configuration.

38. The method as claimed in claim 36, wherein the trigger signal comprises at least one indicator to at least one of:
a. at least one sub-configuration
b. at least one first CSI report configuration, and
c. at least one second CSI report configuration.

39. The method as claimed in claim 25, wherein the at least one second configuration comprises at least one of at least one first resource set configuration and at least one second resource set configuration.

40. The method as claimed in claim 39, wherein the at least first resource set configuration and the at least second resource set configuration of the at least one second configuration further comprises a type field to indicate one of SBFD and non-SBFD.

41. The method as claimed in claim 39, wherein the first resource set and second resource set are one of:
a. channel state information reference signal (CSI-RS) for downlink, and
b. sounding reference signal (SRS) for uplink.

42. The method as claimed in claim 25, wherein performing the reception comprises at least one of:
a. measuring at least one first CSI quantity using at least one CSI reference signal (CSI-RS) in non-SBFD time resources, and
b. measuring at least one second CSI quantity using at least one CSI-RS in SBFD time resources.

43. The method as claimed in claim 42, further comprises one of:
a. deriving at least one first CSI quantity based on the at least one second CSI quantity measured in the SBFD time resources, and
b. deriving at least one second CSI quantity based on the at least one first CSI quantity measured in the non-SBFD time resources.

44. The method as claimed in claim 43, wherein the at least one first CSI quantity is derived when one of:
a. CSI-RS is not received in non-SBFD time resources before the CSI reference resource, and
b. CSI-RS is not received in non-SBFD time resources before first CSI reference resource for non-SBFD time resource.

45. The method as claimed in claim 43, wherein deriving at least one second CSI quantity is when one of:
a. CSI-RS is not received in SBFD time resources before the CSI reference resource, and
b. CSI-RS is not received in SBFD time resources before second CSI reference resource for non-SBFD time resource.

46. The method as claimed in claim 25, wherein performing the transmission comprises transmitting a report.

47. The method as claimed in claim 46, wherein the report comprises at least one of:
a. at least one first CSI quantity for non-SBFD time resources and index of at least one first CSI-RS, and
b. at least one second CSI quantity for SBFD time resources and index of at least one second CSI-RS.

48. The method as claimed in claim 47, wherein the at least one first CSI-RS is used for measuring the at least one first CSI quantity, and the at least one second CSI-RS is used for measuring the at least one second CSI quantity.

49. The method as claimed in claim 46, wherein the report is transmitted only when at least one CSI-RS is received in at least one of SBFD time resources and non-SBFD time resources before CSI reference resource.

50. The method as claimed in claim 46, wherein the report is transmitted only when at least one of:
a. at least one CSI-RS is received in non-SBFD time resources before a first CSI reference resource for non-SBFD time resource, and
b. at least one CSI-RS is received in SBFD time resources before a second CSI reference resource for SBFD time resource.

51. The method as claimed in claim 46, wherein transmission of the report is dropped when at least one of:
a. CSI-RS is not received before CSI reference resource,
b. CSI-RS is not received in SBFD time resources before the CSI reference resource,
c. CSI-RS is not received in non-SBFD time resources before the CSI reference resource,
d. CSI-RS is not received in non-SBFD time resources before the first CSI reference resource for non-SBFD time resources, and
e. CSI-RS is not received in SBFD time resources before the second CSI reference resource for SBFD time resources.

52. The method as claimed in claim 30, wherein the at least one second configuration further comprises at least one of:
a. a CSI reference resource,
b. a time restriction for measurement,
c. a first CSI reference resource for non-SBFD time resources,
d. a second CSI reference resource for SBFD time resources,
e. a time restriction for non-SBFD time resources, and
f. a time restriction for SBFD time resources.

53. The method as claimed in claim 52, wherein when the time restriction for non-SBFD time resource is configured, the method further comprises:
measuring at least one first CSI quantity using the most recent CSI reference signal (CSI-RS) received in non-SBFD time resources before one of the CSI reference resource and the first CSI reference resource.

54. The method as claimed in claim 52, wherein when the time restriction for SBFD time resource is configured, the method further comprises:
measuring at least one second CSI quantity using the most recent CSI reference signal (CSI-RS) received in SBFD time resources before one of the CSI reference resource and the second CSI reference resource.

55. The method as claimed in claim 52, wherein when the time restriction is configured, the method further comprises:
a. measuring at least one first CSI quantity using the most recent CSI reference signal (CSI-RS) received in non-SBFD time resources before one of the CSI reference resource and the first CSI reference resource; and
b. measuring at least one second CSI quantity using the most recent CSI reference signal (CSI-RS) received in SBFD time resources before one of the CSI reference resource and the second CSI reference resource.

56. The method as claimed in claim 30, wherein the at least one second configuration further comprises one of:
a. at least one periodic CSI-RS resource, and
b. at least one semi-persistent CSI-RS resource.

57. The method as claimed in claim 30, wherein the at least one second configuration further comprises valid symbol type for CSI derivation.

58. The method as claimed in claim 57, wherein the valid symbol type is one of
a. SBFD time resource,
b. non-SBFD time resource, and c. both SBFD and non-SBFD time resource.

59. The method as claimed in claim 25, wherein reception is performed in at least one of RRC, DCI, and MAC-CE.

60. The method as claimed in claim 1, wherein the first node is at least one of a BS (Base station), integrated access and backhaul (IAB) node and a distributed unit (DU).

61. The method as claimed in claim 25, wherein the second node is at least one of a UE (User Equipment) and a mobile terminal (MT).

62. A base station (BS) for communication in a wireless communication network enabled with SBFD (Subband Full Duplex) operation, the base station comprising:
a processor; and
a memory coupled with the memory, wherein the memory stores program instructions configured to:
configure at least one first configuration for SBFD, wherein the at least one first configuration for SBFD comprises one or more SBFD time resources;
configure at least one second configuration relating to at least one of transmission and reception of at least one of a signal and a channel, wherein the at least one second configuration comprises an indication to perform at least one of transmission and reception in at least one of SBFD time resources and non-SBFD time resources; and
perform one of the transmission and the reception in at least one of at least scheduled SBFD time resource and at least one scheduled non-SBFD time resource based on the at least one first configuration and the at least one second configuration.

63. A user equipment (UE) for communication in a wireless communication network enabled with SBFD (Subband Full Duplex) operation, the system comprising:
a processor; and
a memory coupled with the memory, wherein the memory stores program instructions configured to:
receive at least one first configuration for SBFD, wherein the at least one first configuration for SBFD comprises one or more SBFD time resources;
receive at least one second configuration relating to at least one of transmission and reception of at least one of a signal and a channel, wherein the at least one second configuration comprises an indication to perform at least one of transmission and reception in at least one of SBFD time resources and non-SBFD time resources; and
perform one of the transmission and the reception in at least one of at least one scheduled SBFD time resource and at least one scheduled non-SBFD time resource based on the at least one first configuration and the at least one second configuration.
